(19) United States
(12) Patent Application Publication
(10) Pub. No.: US 2003/0191709 A1
(43) Pub. Date: Oct. 9, 2003

(54) Distributed payment and loyalty processing for retail and vending

(76) Inventors: Stephen Elston, Seattle, WA (US); Brent Bolleman, Redmond, WA (US)

Correspondence Address: Carman Wenkoff, ONTAIN CORPORATION, Suite C-245, 1750 - 112th Avenue NE, Bellevue, WA, 98004, US

(21) Appl. No.: 10/114,634

(22) Filed: Apr. 3, 2002

(51) Int. Cl. G06F 17/60

(52) U.S. Cl. 705/40; 705/14

(57) ABSTRACT

The system described is an electronic payment and loyalty systems for retail and automatic unattended vending. In particular the invention relates to an electronic payment and loyalty system wherein the customer account information is cached in a nonvolatile memory on the payment terminal or point of sale system while addressing the problems of securely storing customer account information, operation of the system during a failure of the server or network, and the use of customer account synchronization scheduling to limit merchant fraud risk in a network or retail locations and to maximize the peak transaction capacity of the available server and network infrastructure. When the customer account information is not available at the payment terminal, transactions are processed with an online connection to the payment server. The invention allows customers to use and fund electronic stored value accounts at merchant locations without the need for an online connection to the payment system server.

### FIELD OF THE INVENTION

This invention relates to electronic payment and loyalty systems for retail and automatic unattended vending. In particular the invention relates to an electronic payment and loyalty system wherein the customer account information is cached in a nonvolatile memory on the payment terminal or point of sale system and addresses the problems of securely storing customer identity information, operation of the payment system during a failure of the server or network, allowing the use and funding of offline electronic stored value accounts, and the use of customer account synchronization scheduling to limit merchant fraud risk in a network or retail locations.

### BACKGROUND OF THE INVENTION

Electronic payment processing for attended retail locations and self-service automated vending locations is usually typically performed using online authorization or offline authentication with a chip or smart card. Payment processors have adopted authorization and authentication processes on a wide scale to prevent fraud losses and to limit abuse of accounts by customers. These approaches are applied to both credit and debit electronic payment accounts, as well as to check authorization and guarantee schemes.

With online authorization system, the payment terminal captures the payment account information and some security information from a magnetic stripe card or other electronically coded token (chip card, RFID device). The payment terminal connects to the payment server or host and requests an authorization. The server returns an authorization or a decline depending on the state and validity of the customer's account. Periodically, the payment terminal submits a settlement batch file to the payment system server, which then creates a settlement batch to transfer funds from the customers Financial Institution (FI) to the merchant's Demand Deposit Account (DDA). Existing prior art online authorization systems include those operated by Master Card International, Visa International, and American Express along with numerous smaller networks and private label systems.

In modern offline payment systems the customer account information is stored in contact-based or contact-less chip or smart cards. The smart card authenticates itself to the payment terminal typically using cryptographic methods. If the card is successfully authenticated and the payment account parameters are within acceptable limits for the transaction the terminal authorizes the transaction. Thus, the transaction can be authorized without a network connection to the payment system server or host. Periodically, the payment terminal submits a settlement batch file to the payment system server, which then transfers funds from the customers Financial Institution (FI) to the merchant's Demand Deposit Account (DDA). In addition, the data stored on the customer's smart card is periodically updated or synchronized with the payment system server or host. Existing prior art smart card based offline authorization systems include those operated by Master Card International, Visa International, and American Express along with numerous smaller networks. Open applications standards for smart card payment system can be found in a number of sources including those from the Common Electronic Purse Specification volumes; Business Requirements, Version 7.0, March 2000, Functional Requirements, Version 6.3, September 1999, and Technical Specification, Version 2.3, March 2001; the Guidelines for Developing Applications on Open Platform Cards, May 7, 2001 from Visa International; and the Integrated Circuit Card Specification for Payment Systems, Book 2, Security and Key Management, Version 4.0, December 2000, Book 3, Applications Specification, Version 4.0, December 2000, and Book 4, Card Holder, Attendant, and Acquirer Interface Requirements, Version 4.0, December 2000.

The same online and offline technology is applied to customer loyalty systems. Loyalty systems issue loyalty points and create electronic offers or promotions as customers perform transactions with merchants. Once points are issues these systems allow customers to redeem the value of the loyalty points, electronic offers and promotions toward purchases of goods and services from the merchant. The payment system uses an online or offline authorization process to control the redemption of this promotional value.

Both the online and offline methods of have significant drawbacks for both merchants and consumers when applied to low value or frequent transactions. Online authorization requires a data network connection from the payment terminal to the payment system server and host. The cost of this data connection must be included in the transaction processing costs. Further, creating the network connection and the processing of the authorization by the central server increase the transaction processing time for both the merchant and the consumer. Smart card based systems do not require network connections for each transaction, reducing network cost and reducing transaction processing time. However, both contact-based and contact-less smart cards are considerably more expensive to issue than conventional magnetic cards. Further, all issued smart cards must have their software updated to allow the merchant or the payment processor to deploy any additional applications (e.g. a new electronic coupon algorithm), creating versioning and synchronization issues on a large scale, potentially across hundreds of millions of issued cards, and possibly creating a shortage of memory space on older versions of the card.

Caching of applications data or content from a set of centralized servers onto remote client fixed wireless or mobile or fixed wireless computer systems is well know. In U.S. Pat. No. 6,243,755 to Takagi and Kamitake a predictive algorithm to cache the information most likely to be needed by the user in a nonvolatile memory on the user's mobile terminal from a centralized server is disclosed. This approach only addresses serving individual users, rather than large groups of customers and does not address the risk of fraud as would be encountered in a payment system.

Caching of information on Point of Sale (POS) systems and payment terminals is an established practice. WO 00/14691 to Yoshihiro et. al. discloses a system in which payment account information is cached onto individual POS terminals from a server located at the store location. This system does not address the problems associated caching payment account information across multiple store locations. JP10198634 to Ken discloses a system in which merchant personnel or customers can load payment account information onto POS systems using email or other electronic messaging. This system does not address loading the information automatically onto the POS system or payment terminal based on a predicative algorithm.

A number of systems electronically manage coupons, loyalty points or other promotions based on customer transaction histories stored at the point of sale either in the POS system or some other suitable server at the merchant store location. U.S. Pat. No. 6,321,210 to O'Brien et. al., WO 02/01433 to Bernard and Bertrand, JP11003472 to Mitsuo, WO 01/69465 to Peters, and U.S. Pat. No. 5,642,485 to Deaton and Gabriel disclose systems for accumulating customer transaction histories at the point of sale. None of these systems discusses the sharing of this information between different locations or the complexities involved in using stored customer payment account information in a network of related stores.

U.S. Pat. No. 6,334,108 to Deaton and Gabriel discloses a system that synchronizes both customer payment account information and loyalty information between centralized servers and a network of POS systems at retail locations. This system also takes various measures to limit the fraud exposure for the customer payment account information cached in the POS systems at the merchant store locations. However the disclosed system does not address the problems of securely storing customer identity information (e.g. account number and PIN) in the POS system or payment terminal as is required by many payment system rules and regulations, operation of the electronic payment and loyalty system during a failure of the server or network, management of the server and network resources at peak transaction times, the funding of stored value accounts at the point of sale, or the use of customer account synchronization scheduling to limit merchant fraud risk in a network or retail locations using the system.

The use of electronic payment and loyalty applications has been limited in the areas of unattended automatic vending and related applications such as automated fuel dispensing or the distribution of prepaid cards, by network and transaction processing costs or the costs of distributing smart cards.

U.S. Pat. No. 5,845,256 to Pescitelli and Schuman discloses a system which caches transaction information in an automatic vending machine which is then loaded to a centralized server in batch for processing. This invention does not address fraud management and limits the vending to a product (insurance) having no value until the offline processing has been successfully completed, limiting the opportunities for fraud.

U.S. Pat. No. 5,637,845 to Kolls, discloses a system allowing the use of electronic payment cards at vending machines using an online authorization process. This invention does not address the cost issues of online payment processing and is therefore limited to high-value items such as prepaid telephone cards.

EP 0287367 to King, and U.S. Pat. No. 6,003,008 to Postrel et. al. disclose systems for performing offline electronic payment transactions using stored customer payment account information with vending machines on aircraft or ships. Neither of these inventions address the synchronization and security issues involved in performing offline payment transactions at a network of vending machines or customer loyalty functions.

Electronic payment with electronic debit and credit cards using an online authorization for automated or semi-automated fuel dispensing is well known to those skilled in the art. JP 11102482 to Junichi discloses a fuel POS system where customer identification and product purchase information is stored locally. This system does not address the synchronization required to manage this stored information in a network of fueling locations. U.S. Pat. No. 6,073,840 to Marion discloses an automated fuel payment system using Radio Frequency Identification (RFID) devices with an on-line payment authorization. Merchants using this system must pay the full cost of online payment processing.

### SUMMARY OF THE INVENTION

The present invention overcomes the deficiencies of prior art payment systems by caching customer account information in a nonvolatile memory on the payment terminal. The information is cached in a secure nonvolatile storage on the terminals at the merchant locations where the customer is most likely to execute transactions. Customer account data, transaction data, including settlement information, are periodically synchronized with the payment system server.

Through secure caching of customer account information the present invention enables low cost offline authorizations, with the corresponding improvements in transaction speed and without the need to issue costly smart cards and without undue fraud risk. The system of the invention is applicable to electronic payments, electronic loyalty, and electronic coupons and promotions. The system of the invention supports virtually any payment scheme, including credit account payments and debit account payments including direct debit from a customer's demand deposit account using card based debit, ACH or check draft capture, as well as payment stored value or prepaid accounts. Another aspect of the invention allows customers to add funds to stored value accounts while at the merchant's location either with an electronic payment account, with cash or by check.

The customer account information cached in the payment terminal includes that used for electronic payment as well as loyalty functions. The cache or nonvolatile memory of the terminal also holds transaction data, business rules for the payment and promotion applications and security data. Customer account specific business rules stored in the payment terminal are used to limit fraud risk, including limits on payment accounts and verification of the validity of coupons and other promotions.

Account numbers and security codes stored on any convenient payment token are used to reference customer account information for the payment system of the invention. The token can be one used for general payment applications (i.e. a credit card or debit card), can be issued by the merchant or can be issued by the operator of the payment system of the invention. Alternatively, the token can be a device owned by the customer, such as a wireless device, possibly one incorporating cryptographic security capability. Regardless of the payment token or identifier used, the payment system of the invention provides the customer access to any of several payment, loyalty or promotional accounts. Thus, one or more tokens act as surrogate tokens for other accounts. For example, a customer can use a credit card to both make payment and access loyalty and promotional accounts. In another example, the customer can use the identifier or token (possibly combined with the entry of shared secret information) to use a check (and possibly a check guarantee service) at the merchant's location.

In the preferred embodiment of the invention, a cryptographic hash of some convenient account number, an optional security code and customer shared secret information references customer account information (typically a password or PIN). The use of a hash allows the customer account information to be referenced without the account number or shared secret information being stored in the nonvolatile cache memory of the payment terminal at the merchant's location.

If a customer, whose account information is not in the cache memory on the terminal at a particular merchant location, wishes to perform a transaction at that location, the payment terminal connects to the payment system server through a data network to access the customer account information. At the same time, the payment system server of the invention can use the network connection to synchronize account and transaction data.

The payment server of the invention controls the synchronization data in the payment terminal cache memory to regulate the capacity demands on the server and data network and to limit fraud risk. At times of peak transaction rates the server limits the volume of data transferred to a minimum. The processing load for transactions is distributed to the payment terminals to the extent possible. This regulation of synchronization or online data volume and the distribution of transaction processing reduces the required telecommunications or data network capacity required as well as optimizes use of the server equipment for a given transaction rate capacity.

The central server of the payment system of the invention performs centralized fraud management. The server performs fraud scoring and account activity profiling for both new accounts and the ongoing use of established accounts. Based on these risk scores the server determines transaction limits for customer accounts, customer account and transaction data synchronization schedules with the nonvolatile cache memory in the payment terminals and identifies high risk accounts for which no account information or account blocking information is cached on the payment terminals.

An object of the invention is to improve transaction speed and lower network costs by caching customer account and transaction data in a payment terminal or POS system at a merchant's retail location while maintaining payment system security by storing account numbers, optional security codes and PIN codes in the form of a non-reversible cryptographic hash rather than in unencrypted form. Account and transaction data indexed through the cryptographic hash includes payment, loyalty, electronic coupons and promotional purses.

Another object of the invention is to increase peak transaction capacity of the payment system infrastructure, including servers or hosts and network or telecommunications facilities, by distributing processing load to terminals maximizing system capacity at peak demand times. The server regulates synchronization and network use to manage capacity at peak transaction rate times.

Another objective of the invention is to provide robustness or continuity for the electronic payment and loyalty functions at each merchant store location in the event of network or server failure.

Another object of the invention is to reduce the merchant's fraud risk through global server control of customer account and transaction information synchronization schedules. During these synchronization events rules to prevent risk at each store location are dynamically updated on each payment terminal.

Another object of the invention is to limit the merchant's exposure to high-risk transactions or accounts by not caching in nonvolatile memory account information for high-risk customers on the payment terminal under control of the server.

Another object of the invention is to allow the use of stored value or prepaid accounts for customer payments, which the customer can fund at the merchant's payment terminal using either an electronic payment account or with cash.

Another object of the invention is to provide the hireactical security and security management required to operate the system using the existing corporate and franchises structures existing in many retail environments.

Yet another object of the invention is to allow low cost and low risk payment and loyalty functions at both attended and unattended merchant retail locations including stores, vending machines, and fueling stations and without the need to distribute smart cards to customers.

It will be appreciated that the foregoing statements of the features of the invention are not intended as exhaustive or limiting, the proper scope thereof being appreciated by reference to this entire disclosure and to the substance of the claims.

### BRIEF DESCRIPTION OF THE DRAWINGS

The invention will be described by reference to the preferred and alternative embodiments thereof in conjunction with the drawings in which:

FIG. 1 is an overall diagrammatic view of the preferred embodiment of the system or the invention;

FIG. 2 is a block diagram of the payment terminal used at a merchant terminal according to the preferred embodiment;

FIGS. 3A, 3B, 3C, 3D, 3E, 3F, 3G, 3H, 3I, 3J, and 3K is a flow chart of a basic transaction for a payment at a merchant terminal according to the preferred embodiment;

FIGS. 4A, 4B, and 4C is a flow chart of an electronic payment according to the preferred embodiment;

FIGS. 5A, 5B, 5C, 5D, and 5E is a flow chart for customer account creation according to the preferred embodiment;

FIGS. 6A, 6B, and 6C is a flow chart showing a payment account authorization according to the preferred embodiment; and,

FIGS. 7A, 7B, 7C, 7D, 7E, and 7F show the nonvolatile memory data structure for the merchant payment terminal according to the preferred embodiment.

### DETAILED DESCRIPTION OF THE PREFERRED AND ALTERNATIVE EMBODIMENTS

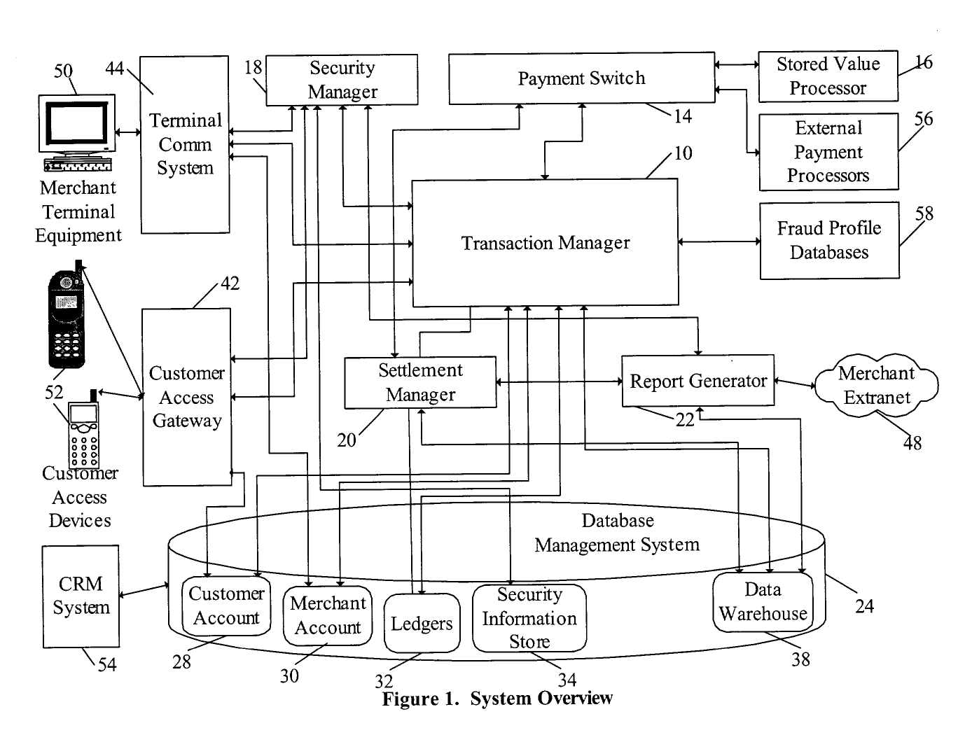

The preferred embodiment of the invention is used to facilitate transactions with customers who wish to make payment and gain loyalty benefits at one of several merchant locations. The customer and merchant employee interface with the payment system using dedicated terminals or other Point Of Sale (POS) systems at the merchant locations, which communicate over a data network with centralized servers or hosts. In the preferred embodiment customer account information is cached in a secure manner in nonvolatile memory on the payment terminal or POS system and synchronized with the host as required. The major system components of the payment system used in the preferred embodiment of the invention are illustrated in FIG. 1. However it will be appreciated that many aspects of the invention are equally applicable to other embodiments of payment systems that might be contemplated for use in conjunction with payment and electronic loyalty systems at physical merchant locations.

The major system components of the preferred embodiment include:

Transaction manager 10

Payment switch 14

Stored value processor 16

Security manager 18

Settlement manager 20

Report generator 22

Database 24 and a database management system

Terminal communications system 44

Merchant IT equipment 50

Customer access gateway 42

The database 24 resides in non-volatile storage such as hard disk drives and includes:

Customer accounts 28

Merchant accounts 30

Transaction ledgers 32

Security information store 34

Data warehouse 38

Not all of the illustrated components are necessary to the functioning of the invention. For example, a stored value processor 16 is desirable to facilitate payment, but such a payment option is not critical to all embodiments of the invention.

The principal components identified above are preferably housed and executed on one or more servers dedicated to the payment system of the invention and remote from the merchant store locations. Many of the components may be implemented as distributed sub-systems.

The merchant terminal equipment (50) deployed at each merchant store location is an integral component of the payment system of the invention. The merchant terminal equipment communicates with the host components through the terminal communications system (44). The components of the merchant terminal equipment are discussed in a section below.

External components interfaced to the RO system include:

External payment processors 56

Merchant extranet 48

Customer access devices 52

CRM system 54

Fraud profile databases 58.

A summary of the interaction between these components is first presented in this section.

Summary of Interaction of Components of the Payment System

The following is an overview of the functions of the main components or subsystems of the preferred embodiment of the payment system of the invention.

The transaction manager 10 controls the overall transaction flow and executes the required business logic. The transaction manager uses the services of the other components of the payment system, including the payment switch 14, the security manager 18, and the terminal communications system 44. The transaction manager or the central processor (100) in the merchant terminal equipment (50) computes the price, promotional value, tip, fees and taxes. If a payment authorization is required the transaction manager receives the authorization from either the internal stored value processor (16) or external payment processors (56) through the payment switch (14). During transactions that cannot be executed using information cached on the terminal (50) the transaction manager and the terminal communicate through the terminal communications system (44) to exchange the required account information.

The security manager 18 controls all access to data, reports and system services for the payment system server, including access for both merchant employees and customers. The report generator 22 provides merchant personnel with reports on payment and loyalty transactions from the data warehouse 38 and under the control of the security manager 18.

The security manager uses a set a set of security protocol adaptors to accommodate the authentication protocols used by the various merchant and customer connections to the system. For data or system service access for merchant personnel the security manager (18) authenticates the person and determines the permissions for data and service access. Authentication is done when personnel access the payment system over the merchant extranet (48) or through terminal or POS equipment (50) at a store location. If personnel attempt to access data or services for which they are not authorized security manager (18) will prevent them from doing so. Customers access the system through either merchant IT equipment 50 connected through the terminal communications system 44 or with a variety of wired or wireless customer access devices 52 connected through the customer access gateway 42. The security protocol adaptors in the security manager 18 accommodate the security protocols used by each of these customer connections.

The security manager (18) and the transaction manager (10) manage merchant fraud risk within the payment system. Risk management occurs both when new customer payment accounts (28) are authorized and as an ongoing process throughout the life to the customer account.

The transaction manager 10, settlement manager 20, report generator 22, and security manager 18 each make use of the records maintained in the database 24. This information includes the customer account information (28), merchant account information (30), and security access and authentication information in the security information store (34). Certain transaction records are maintained in ledgers 32 and an archive of transaction details is maintained in the data warehouse 38.

To maintain security of the entire payment system server network security measures are employed. Firewalls, encryption schemes (including the use of Virtual Private Networks or VPNs) and other measure to limit access are employed on all external network connections and select internal network connections. Security equipment and processes are employed in the terminal communications system (44), the customer access gateway (42), the merchant extranet (48), the payment switch (14) and connections to the CRM system (54).

The RO system is adapted for use in association with a chain of affiliated merchants, for example in a franchise group. The security information store (34) is maintained wherein merchant location-specific information is retained to allow the payment system to be used seamlessly across the various merchant locations in the chain and across merchant brands with differing ownership. Such information includes for example payment types accepted, payment accounts, settlement protocols and rules, and administrative privileges.

For affiliated chains of merchants the security information store (34) is organized in a hierarchical manner. Merchant brands are divided into administrative groups that are generally organized along corporate organizational lines. A merchant brand can be divided into one or more geographic divisions and the geographic divisions divided into one or more geographic subdivisions. These subdivisions can include the territory of an individual franchise operator. There can be multiple levels of geographic subdivisions as required by corporate organizational structure. Geographic divisions or subdivisions are divided into individual store locations. Merchant employees and RO system administrators are organized into functions or “roles” that are used to simplify administration of permissions (for example to authorize refunds or to change merchant account information). These permissions are set through an administrative interface. Merchant employee permissions and roles are organized hierarchically in a manner that reflects corporate and ownership structure. Examples of levels in this hierarchy may include:

1. Corporate,

2. Geographic division or region,

3. Group of store or franchise group,

4. Store employees.

Roles within these levels include:

1. Financial manager,

2. Marketing or product manager,

3. Operations manager,

4. Franchise owner,

5. Store manager, and

6. Store employee.

A security administration interface itself contains a hierarchy of security administration authority. Different levels within an organization can set the permissions and create accounts for personnel within their part of the company. Generally, security administrators can create or delete accounts for their level in the hierarchy or below. Thus, control of the administrative function is itself hierarchical. As an example, administrators at a corporate level can set permissions for corporate employees at the corporate, regional or divisional level. Administrators at the regional or divisional level can set permissions for personnel within that division or region including store managers, franchisees or store owners. Administrators at the store or franchisee level can set permission for personnel directly associated with that store or stores. Levels and authorities for company-owned stores within a chain are generally structured differently than for franchisee-owned stores. The security administration interface is used to create or delete new merchant employee and store location accounts. Generally, security administrators can create or delete accounts for their level in the hierarchy or below. For example, administrators at the store or franchise level will create or delete store employee accounts.

The customer account 28 contains all payment and loyalty information applicable to each customer for a variety of merchant brands and store locations. The applicable portion of the customer account information (112) is loaded into a nonvolatile of cache memory (110) on the terminal (50) at specific merchant locations to reduce transaction time and costs, while managing fraud exposure.

Each merchant location is associated with a merchant account 30 allowing the payment system to tailor payment, loyalty processing, and settlement rules and conditions applicable to that merchant location. The merchant location can be a part of a chain of affiliated merchants or a single stand-alone location. A separate merchant account is required for each store location in either case. The merchant account (30) contains basic store information including a store number of other identifier, the store name or location name. The account also contains the geographic or other company divisions the store is associated with, and one or more brand identifiers associated with the store. The merchant account contains (or has links to) one or more financial account records showing all transactions at that store location and preferably including:

1. The merchant account number for that account,

2. The type (settlement, promotional, etc) of account,

3. The account owner, or merchant of record,

4. The current settlement balances for that account,

5. The financial institution holding the Demand Deposit Account, and

6. The transaction history (or links to the ledger system) for that account,

7. Links to the security information store (34) for the employees at the store location,

8. Account contact information, including the name of the account owner or primary contact, the contact telephone number, the contact's email address, the mailing address, and alternative contact information as may be required, and

9. The payment types and customer authorizations accepted by the merchant location, and any authorization rules, such as value limits, need for signature capture, etc, for each payment type.

The settlement processor 20 creates financial settlement files for each store location using the service. These files are transmitted at required time intervals through the payment switch (14) to the appropriate payment processors (56), who then settle funds to each merchants demand deposit account. In general each store location of a chain of merchant will have individual demand deposit accounts and will be settled separately.

Customers using various types of wireless and fixed wired devices 52 to access the services of the RO system through the customer access gateway 42. The customer access gateway interfaces with a variety of public access wide area networks or local area wireless base stations (104) in the merchant terminal equipment (50).

External Components

The RO system can use one or more external payment providers 56. The services of these providers can include multiple payment types including credit, debit, and stored value.

The merchant employees use the merchant extranet (48) to access reports created by the report generator (22) and administer the payment system. Access to the extranet can be through the Internet, telephone, or other suitable means.

The transaction manager (10) and the security manager (18) use the external fraud profile database (58) as a source of information by for the authorization of new customer accounts and the ongoing management of merchant fraud risks.

Customers can access the services of the RO system using a wide variety of wireless and fixed wired devices 52, including telephones, text messaging devices and Internet terminals connecting to the customer access gateway 42.

The CRM system 54 is used to perform customer support and relationship management functions using the records in the database, including the customer account 28 and data warehouse 38. The CRM system can be operated by a variety of entities including the RO system service provider, a financial institution or the merchants themselves.

Distributed Components

The payment system may be distributed between multiple locations and entities. Even individual components, including those shown in FIG. 1, may themselves be partitioned and distributed. For example, the customer access gateway 42 may be partitioned between any combination of telecommunications carriers and Internet Service Providers (ISPs). In another example, the security manager 18 may be under the control of and reside within a number of entities such as telecom carriers, ISPs and merchant or third party data centers. The database 24 may also be distributed such that different data tables (customer account 28 and merchant account 30) are under the control of various entities supporting the payment system, such as ISPs, telecommunication carriers, banks, etc. In some cases, it might also be desirable to have, for example a directory of product offerings, that resides on some combination of merchant terminal equipment 50 at individual stores, centralized merchant data centers and the payment system service contractor.

Terminal Components

The terminal communications system 44 transmits payment and loyalty account information to the merchant terminal equipment 50 at each individual store location. The merchant terminal equipment (50) can include a variety of systems at the store location or distributed to remote data centers including, payment terminals, integrated POS systems, self-service kiosks and associated peripherals.

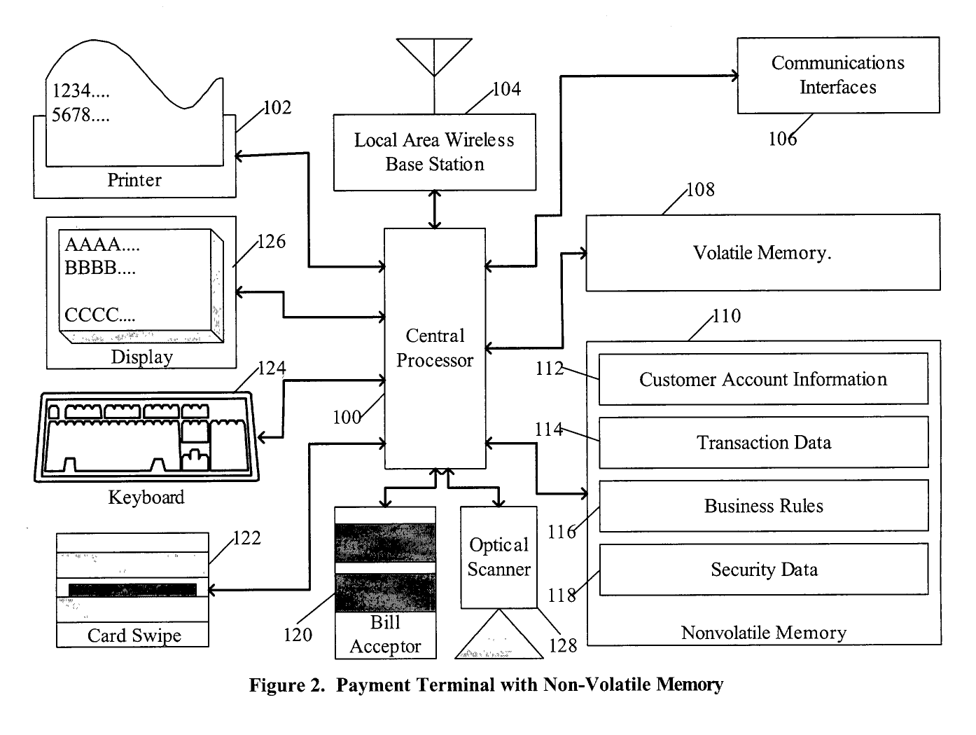

Transaction and customer payment account information are stored in nonvolatile memory in the merchant's payment terminal (50). The key components of the terminal are shown in FIG. 2. It will be clear that the components describe here can be included in any combination of dedicated payment terminal, Point of Sale system, self-service kiosk or other merchant terminal equipment, without changing the nature or function of the invention. Further, the components shown can be distributed between the different systems without changing the nature or function of the invention. The distributed components communicate over any type of suitable wired of wireless data network.

The central processor (100) provides the computing functions required to manage transactions. The central processor interfaces with and controls the other components of the terminal. The optional printer (102) is used to print receipts, signature slips, coupons or any other material required in printed form by merchants or consumers. The communications interfaces (106) are used to connect the terminal to the payment system host or directly to payment processors (56). The network can be any type of data connection including, wired wide area networks, wireless terrestrial networks, satellite networks (VSAT) and using any suitable data protocol such as the Internet Protocol (IP). The terminal can use multiple network connections to communicate with the server and payment processors (56). The central processor (100) uses the volatile memory (108) as it executes the payment algorithm programs. Customers use the bill acceptor (120) to fund stored value accounts as a self-service process. Payment account information is captured using the card swipe (122). It will be understood that a smart card reader, magnetic ink or optical check scanner, or the wireless base-station (14) can be used as well to complement or substitute for the card swipe without changing the nature or function of the invention. Any required manual data entry can be done with the keyboard (124), which can be supplemented with a mouse or trackball (not shown). Information is presented to customers and merchants via the display (126).

Customer account information (112), transaction data (114), business rules (116) and security data (118) are all contained within the nonvolatile memory (110). The nonvolatile memory provides a read/write media for longer-term storage of data. Any type of nonvolatile memory, including hard disk drives and flash memory is suitable.

Customer wireless access devices (52) communicate with the payment system through the local area wireless base-station (104) while the customer is in the store. The wireless base-station can use any suitable Radio Frequency (RF) technology, including those complying with the IEEE 802.11 or Bluetooth standards, or Infrared technology (IR) including the IR Data Access (IrDA) standard. Customer account numbers and security information are exchanged from customer wireless access devices and the terminal through the local area wireless base-station as an alternative to using a card swipe (122) or smart card reader. In an alternative embodiment the wireless base-station communicates with RF Identification (RFID) devices.

The optical scanner (128) is used to read information from customer coupons and other printed offers. The optical scanner can also be used to read customer information if the customer identifier is a bar coded card or other media.

Payment Transaction

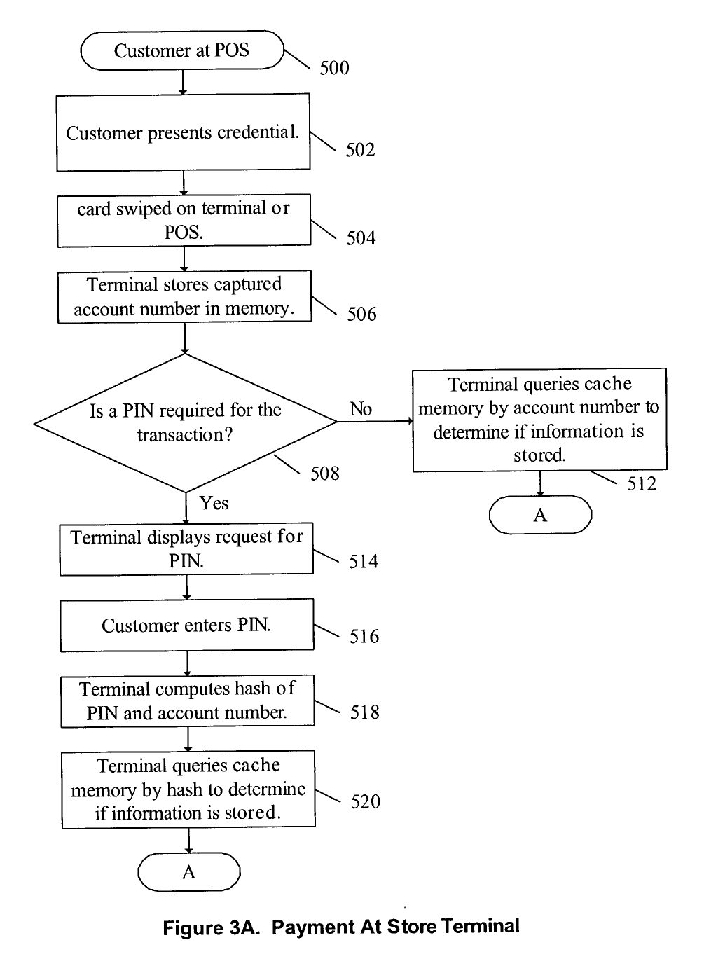

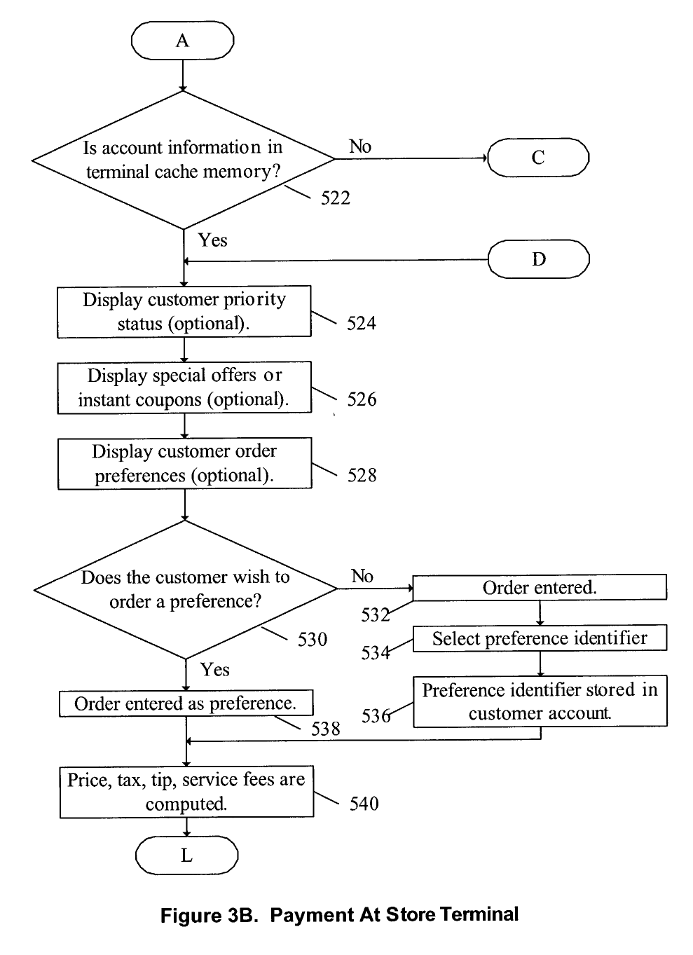

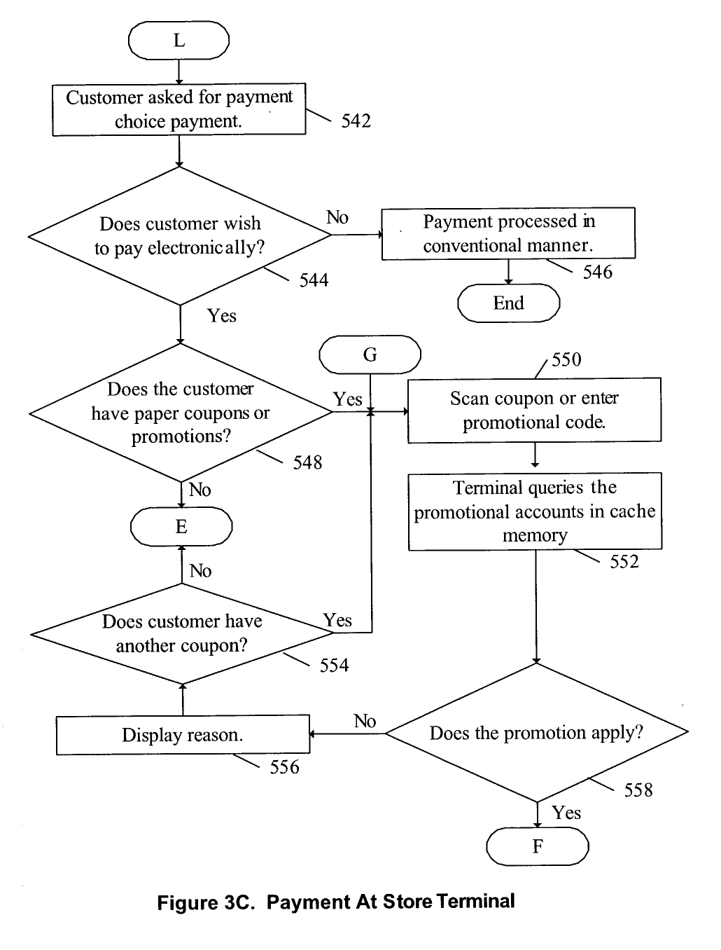

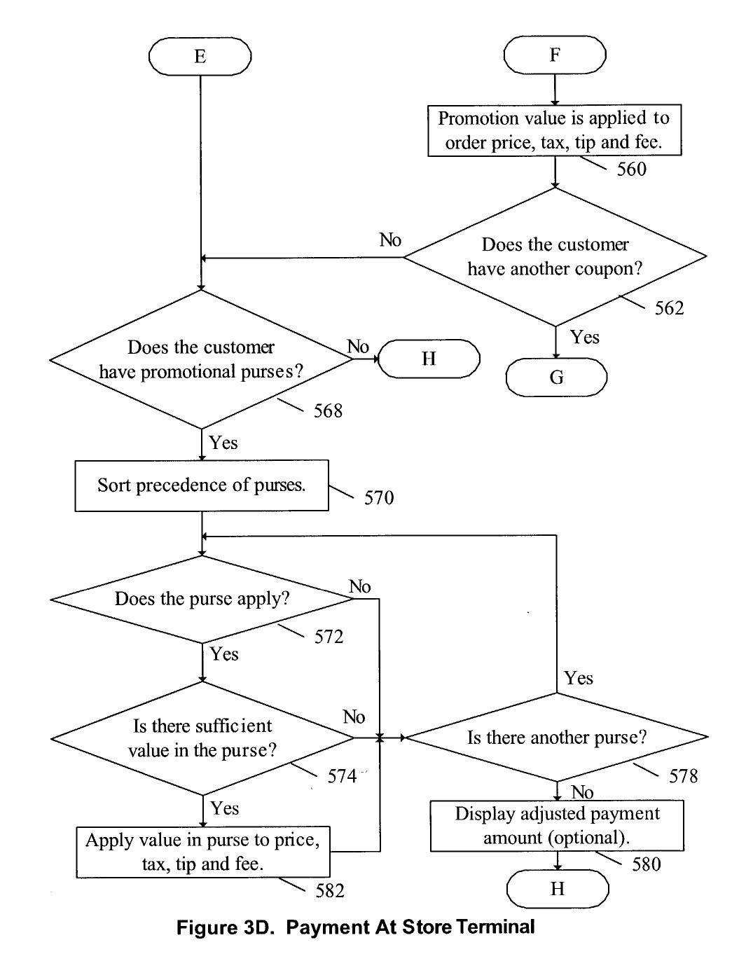

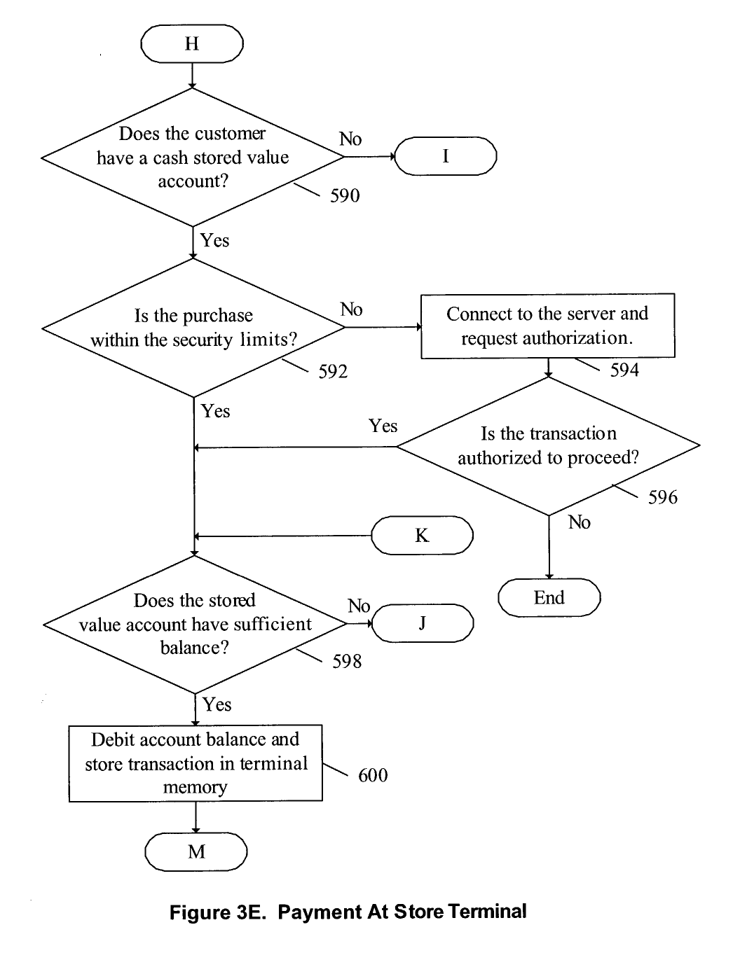

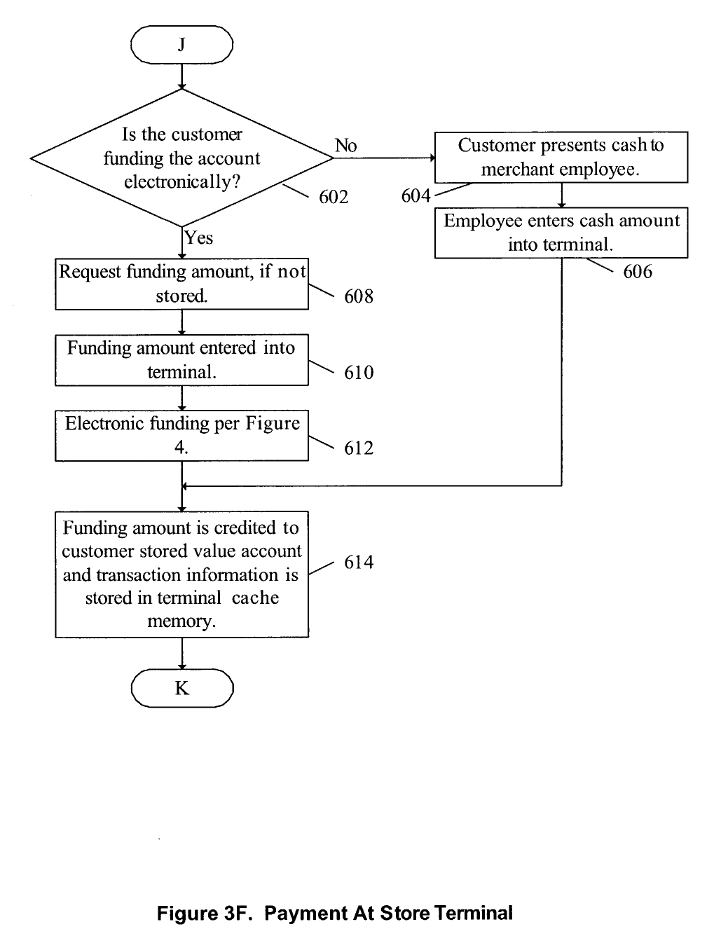

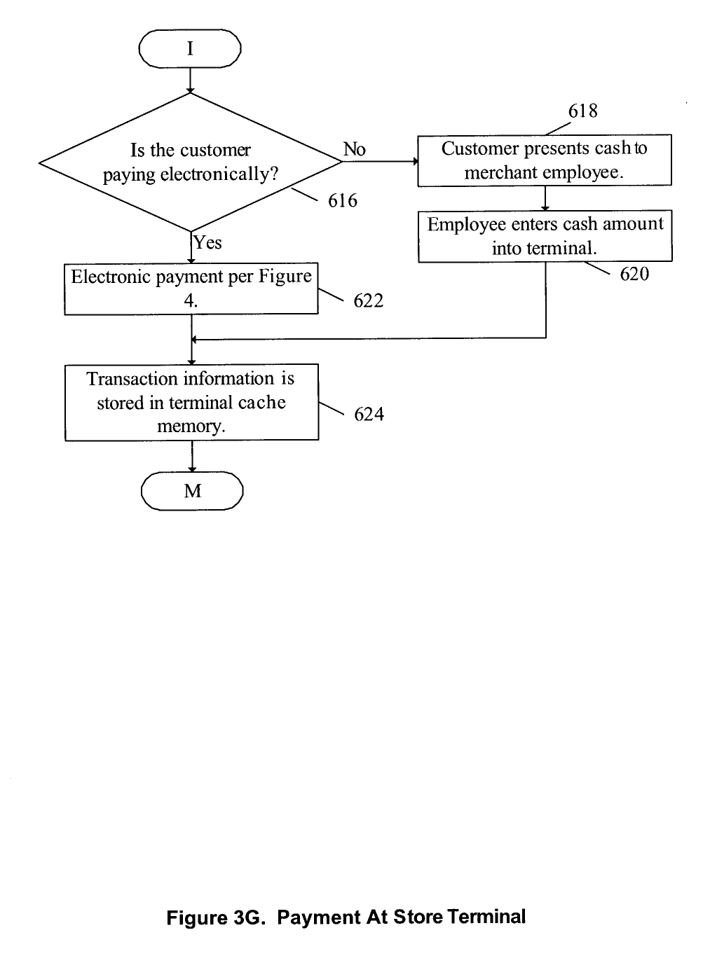

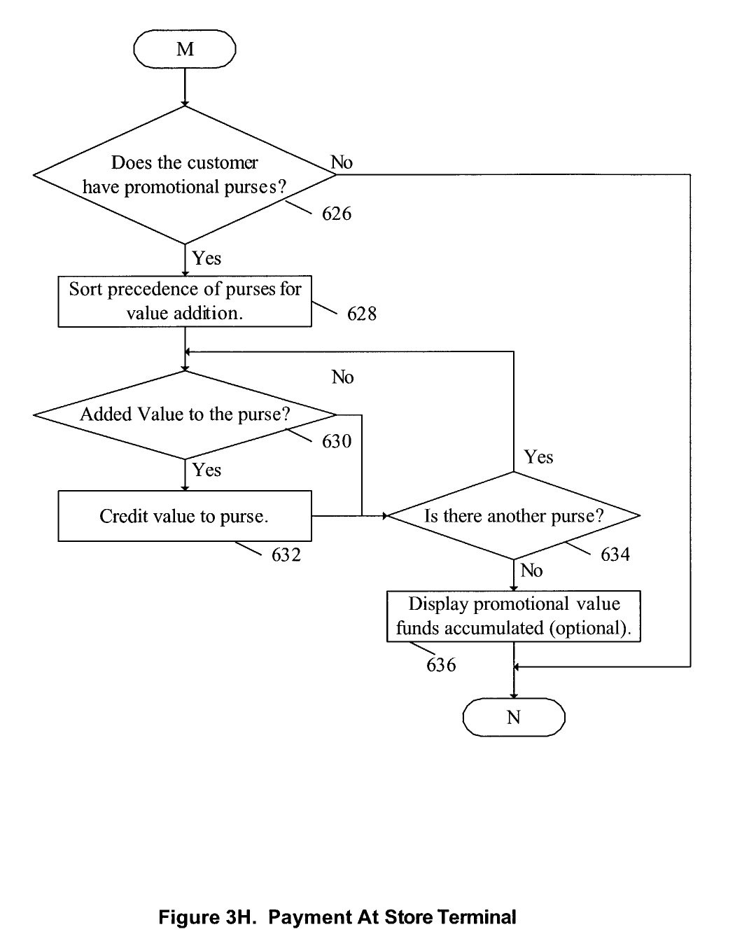

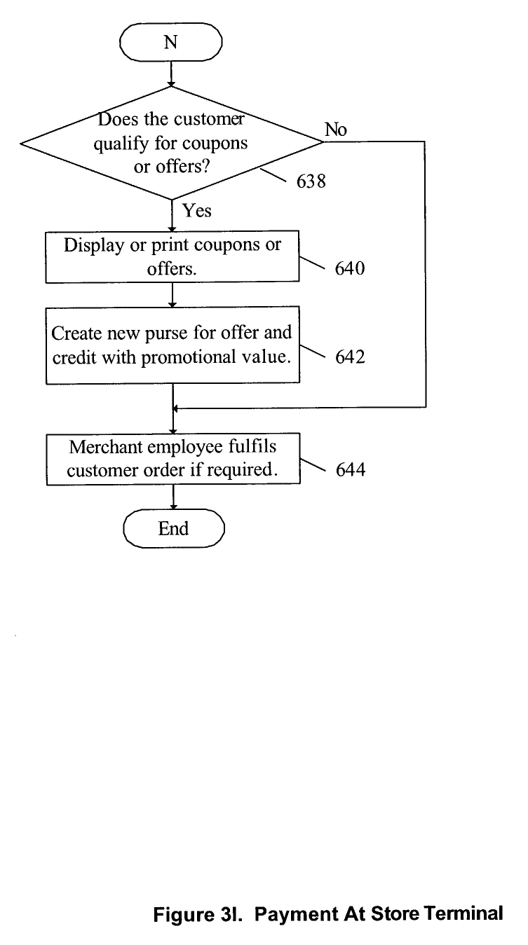

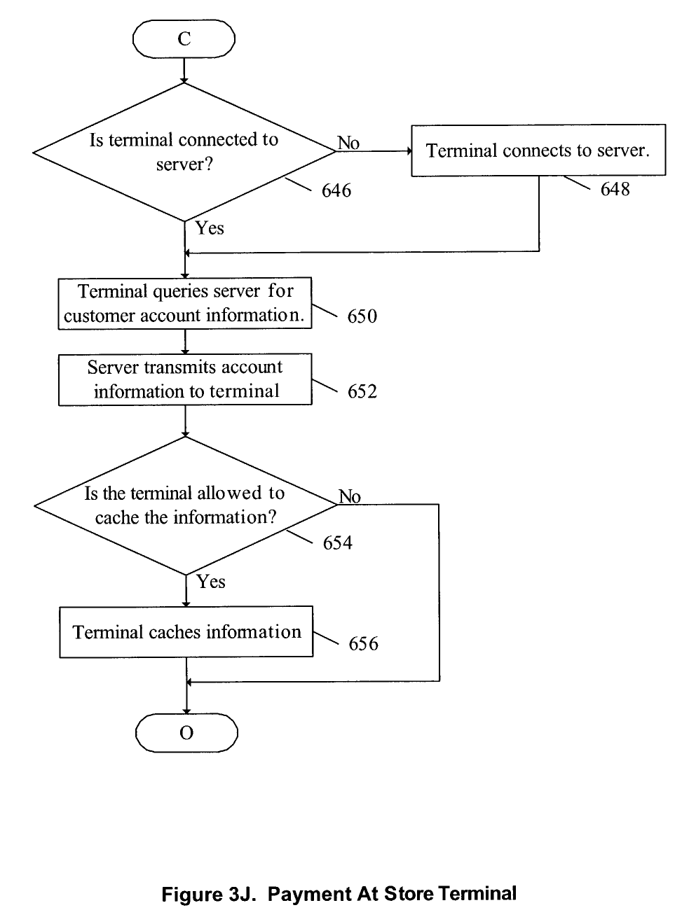

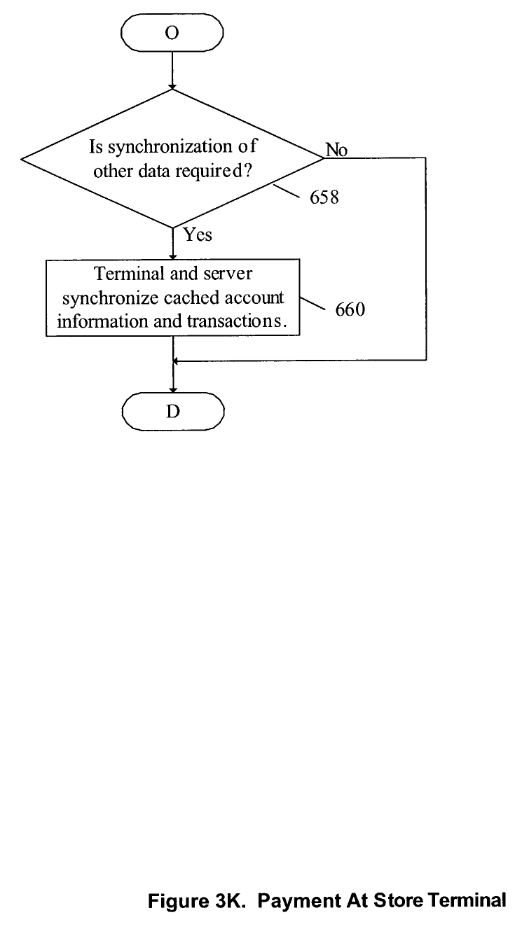

The payment system is used for customer payment at merchant Points of Sale (POS), which include sites attended by a merchant employee or self-service (unattended or semi-attended) kiosks, vending machines or gas pumps. The majority of the transactions are performed using the customer account data stored in the payment terminal without the need to connect to the server through a network. The process flow for these payment transactions is shown in FIGS. 3A, 3B, 3C, 3D, 3E, 3F, 3G, 3H, 3I, 3J and 3K.

Customer Account Retrieval

The process is initiated when the customer arrives at the point of sale (500). The customer presents their payment credential (502) or identifier and the information is captured using the card swipe (504). The terminal stores (506) the captured account number in volatile memory (108). Alternatively, the customer can enter another identifier such as a telephone number or user name.

If the transaction requires a PIN code (508) or other shared secret information the terminal displays (514) the request for this information on the terminal's display (126). The customer enters (516) the PIN typically using the keyboard (124). The terminal central processor (100) computes a hash (518) of the PIN and account number or other identifier. The central processor queries the customer account information (520) from the customer account information (112) in the nonvolatile cache memory (110). If a PIN or other shared secret information is not used the central processor queries the customer account information in the nonvolatile memory by account number or other identifier. The central processor determines if the required data is available (522) in the customer account information.

Customer Order

Once customer account information (112) is available, the terminal optionally displays customer service priority (524) including loyalty points, promotional offers and instant coupons (526), and customer ordering preferences (528) on the terminal display (126). Alternatively, this information can be presented in printed form using the printer (102). If the customer wishes to order a preference (530) the selection is entered (538) into the terminal typically using the keyboard (124). Alternatively, the customer can select an ad-hoc order, which is typically entered (532) through the keyboard (124) or by capturing product information, generally in Universal Product Code format, with a scanner (128). The customer selects the preference number (534) or other identifier for the order if the customer wishes to place the same order in the future. The preference is then stored in the customer account information (112) in the nonvolatile memory (110). It will be understood that the process described is essentially the same when used at an attended point of sale, a vending machine, a self-service kiosk or self-service fueling pump.

Payment, Coupons and Promotions

Once the customer has placed their order, the central processor (100) or other apparatus, such as a POS system, computes the price, tax, tip and service fee for the order (540). The customer is asked for their payment choice (542), typically through the display (126). Alternatively, the choice of payment can be determined in advance and stored as part of the customer account information (112). If the customer wishes to pay electronically (544), they are asked for any paper coupons or promotions (548) they wish to apply to the purchase. The coupon information, including promotion code and value, is captured by scanning with the optical scanner (128) a code on the coupon or manual entering the code (550) using the keyboard (124). The central processor (100) queries the business rules (116) in the nonvolatile memory (110). The central processor determines (558) if the coupon or promotion can be applied to the order. If not, the terminal displays the reason (556) on the display (126) and requests another coupon or promotion from the customer (554). If the customer has another coupon or promotion the process is repeated. If a coupon or promotion applies the central processor (100) applies the value to the price, tax, tip and service fee for the customer's order (560). The customer then has the option to try another coupon or promotion (562), which follows the same process.

The central processor (100) determines if there are electronic promotional purses (568) in the customer account information (112). If purses exist, the central processor sorts the purses into precedence order (570) using the promotional rules. The central processor then determines if the purse applies to the customer's order (572). If so, the central processor determines if there is sufficient value in the purse (574) to be applied to the order and applies this value (582) to the price, tax, tip and service fee as appropriate. Once one purse has been tested and perhaps used, the central processor determines if there is another purse to be applied (578). If so, the process is repeated.

The value of the coupons, promotions and promotional purses that have been applied is shown to the customer (580) via the display (126) or in printed form with the printer (102).

Stored Value Payment

If the customer has a cash stored value account (590) that is to be used for the payment the central processor (100) determines if the purchase is within the security limits set by the server. If not the terminal connects (594) to the server (if a connection is not already open) and requests an authorization for the transaction. If the authorization is granted (596) the central processor determines if there is sufficient balance (598) in the stored value account. If so, the central processor debits (600) the customer's account balance.

If the stored value account does not have sufficient balance additional funds are added to the account. The customer can choose to add funds to the account electronically (602). Alternatively the customer can add funds in cash (604) (or check) by presenting the cash to a merchant employee. The merchant employee enters (606) the cash amount using the keyboard (124). Alternatively, the customer can feed cash into the bill acceptor (120). The bill acceptor then captures the cash amount for the terminal.

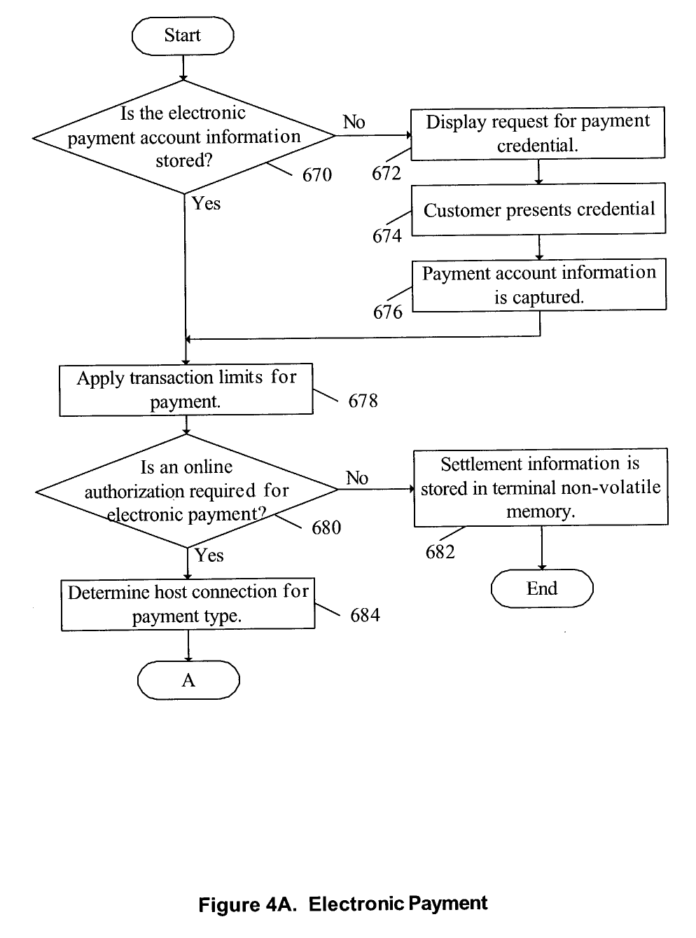

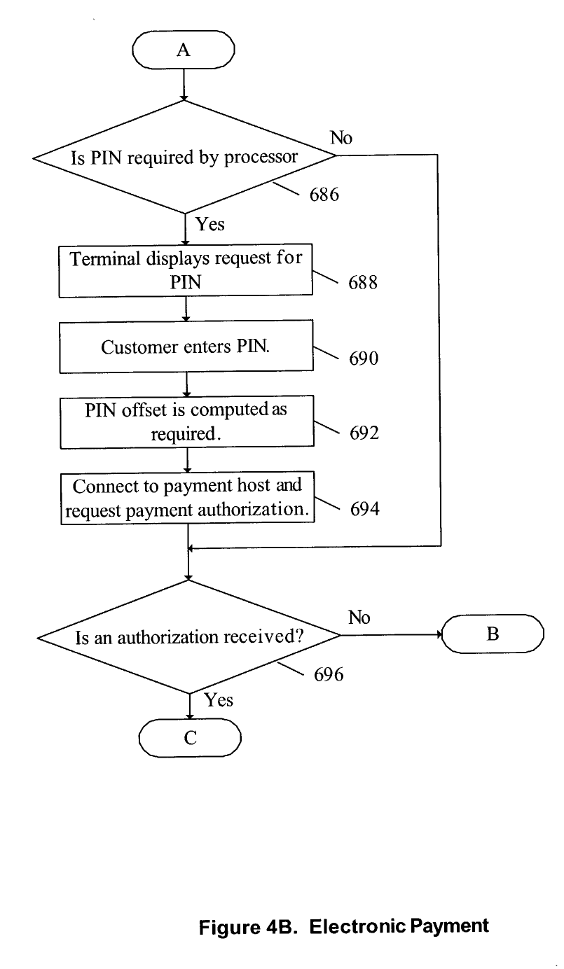

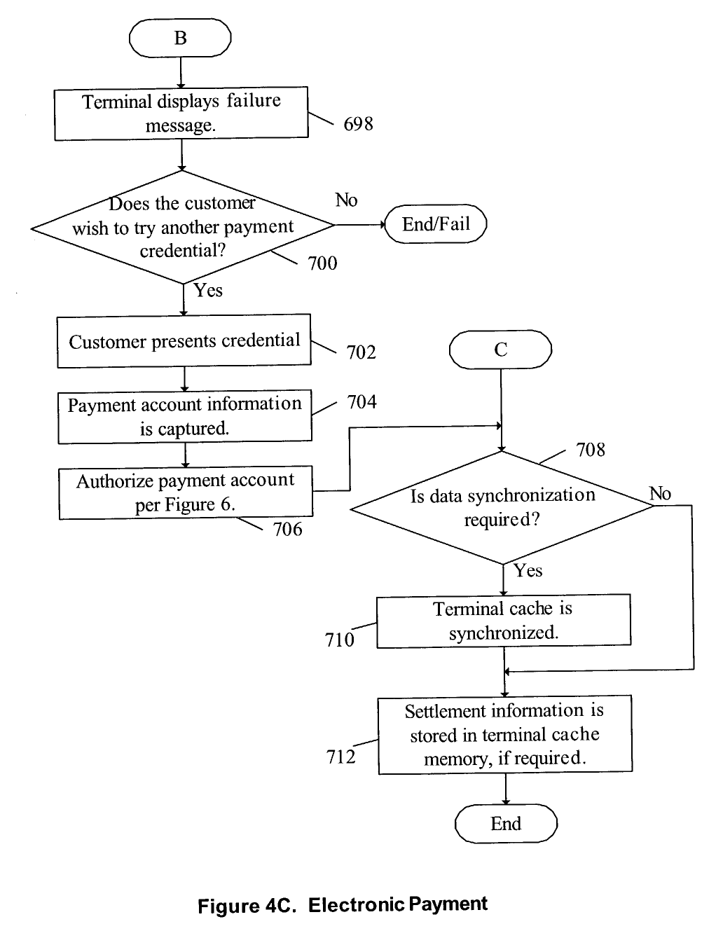

If electronic funding is chosen the terminal requests the funding amount (608) funding through the display (126) and the amount is entered (610) through the keyboard (124) or determined from a value stored in the customer account information (110), which may then be verified through the keyboard. The electronic payment transaction process flow shown in FIG. 4 is then applied.

Once funds have been acquired for the stored value account the central processor (100) credits (614) the stored value account information in the customer account information (112) and the transaction information is stored in the transaction data (114) in the nonvolatile memory (110).

Direct Payment

If a stored value account is not being used, the customer makes the payment directly. The customer is given the choice of paying electronically (616). If the customer chooses cash (or check) they present the cash (618) to a merchant employee. Alternatively, the customer can feed cash into the bill acceptor (120). The merchant employee enters (620) the cash amount using the keyboard (124). Alternatively, the bill acceptor captures the cash amount. If electronic payment is to be used (622) the process flow shown in FIG. 4 is applied. Once the payment process is complete the transaction information is stored (624) in the transaction data (114) of the nonvolatile memory (110).

Adding Value to Promotional Purses

Once the transaction is complete the terminal determines if the customer should receive offers, promotions or coupons. These offers, promotions and coupons can be associated with existing purses or new purses can be created to hold the value.

The central processor (100) determines if the customer has existing promotional purses (626) in the customer account information (112). If so, the central processor sorts the purses (628) into precedence order for the addition of value using rules for the purses. The central processor determines if value should be added to a purse (630), and credits the value (632) to the purse if appropriate. If there are other purses (634) the process is repeated. Optionally the customer is shown (636) the accumulated value in the purses from all offers, promotions, loyalty points and coupons using the display (126) or in printed form using the printer (102).

The central processor then determines if the customer is qualified for other coupons, offers or promotions (638). The terminal displays or prints the coupons or offers (640) on the display (126) or printer (102). Purses are created for the offers and promotions and the value credited to these accounts (642).

If required the merchant employee then fulfills the customer order (634). Alternatively, a vending machine dispenses the selected product.

Data Query and Synchronization

If the customer account information (112) is not cached in the nonvolatile memory (110) the terminal will query the server to get the required information. If the terminal is not connected to the server (646) the terminal connects to the server (648) through the communications interfaces (106). The central processor (100) sends a query (650) to the server through the communications interface. The server transmits (652) the requested account information and indicates if the terminal is to cache (654) this information in the customer account information (112) in the nonvolatile memory (110). If not, the terminal will keep the account information in volatile memory (108) and not retain it once the transaction is completed. If the allowed, the terminal will cache (656) the account data in the customer account information (112) to use during this and subsequent transactions.

If the server determines the need to synchronize other data (658) the server synchronizes (660) customer account information (112), transaction data (114), business rules (116) and security data (118) with the nonvolatile memory (110) or cache memory in the terminal.

The algorithms used to determine which account information is to be cached and when synchronization occurs between the terminal and the server is discussed in the section Data Cache Synchronization below.

Electronic Payment

The invention supports the use of electronic payment both to fund stored value accounts and for direct payment. In either case the process shown in FIGS. 4A, 4B, and 4C is followed.

If electronic payment account data is not stored (670) in the customer account information (110) the terminal requests the customer's payment credential (672) though the display (126). The payment credential could include a customer wireless access device (52), a magnetic stripe card, an optically coded card or other media, a smart card, a check draft or an RFID device. The customer presents the payment credential (674) and the payment account information is captured (676).

The central processor (100) applies transaction limits (678) regardless if stored payment account information or captured payment information is used. If the transaction is determined to be within the limits (680) the payment information is stored (682) in the transaction data (114) in the nonvolatile memory (110) for latter settlement.

If an online authorization is required (680) the terminal determines the connection path to used for the processor and payment type (684). If a PIN or other shared secret information is required by the processor (686) the terminal requests this information (688) though the display (126). The customer enters the PIN (690) thought the keyboard (124) and the central processor computes a PIN offset (692) or other hash as required. The terminal connects to the payment processor host (694) and requests an authorization. The connection path is through the communications interfaces (106) and can be with the payment system server of the invention or directly to the payment processor's host.

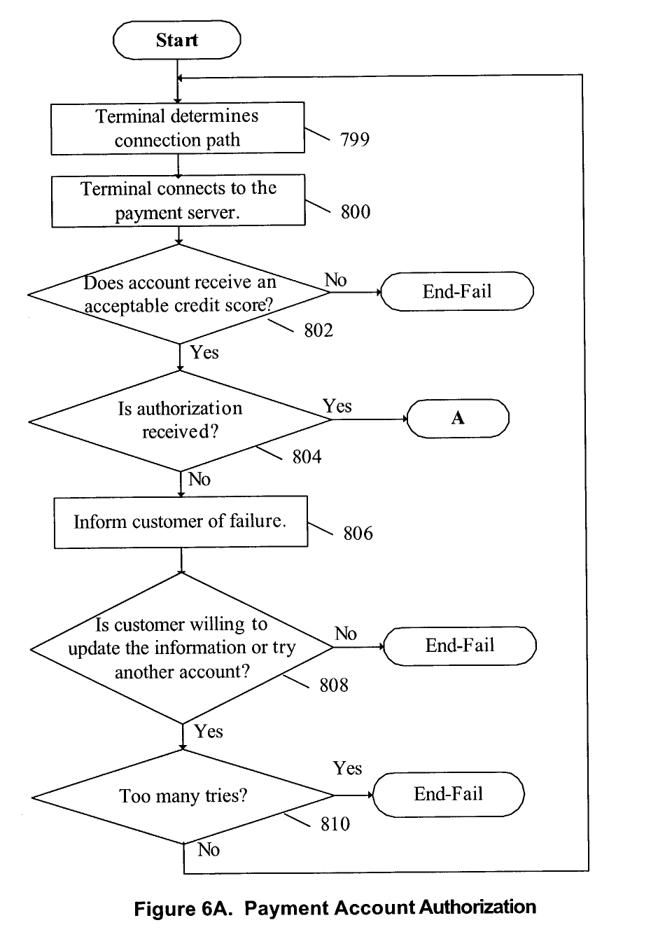

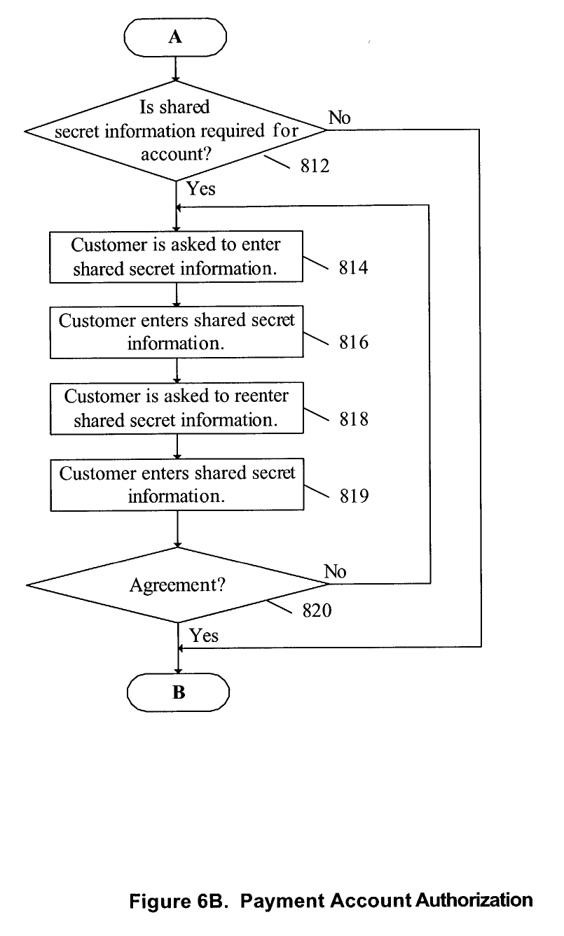

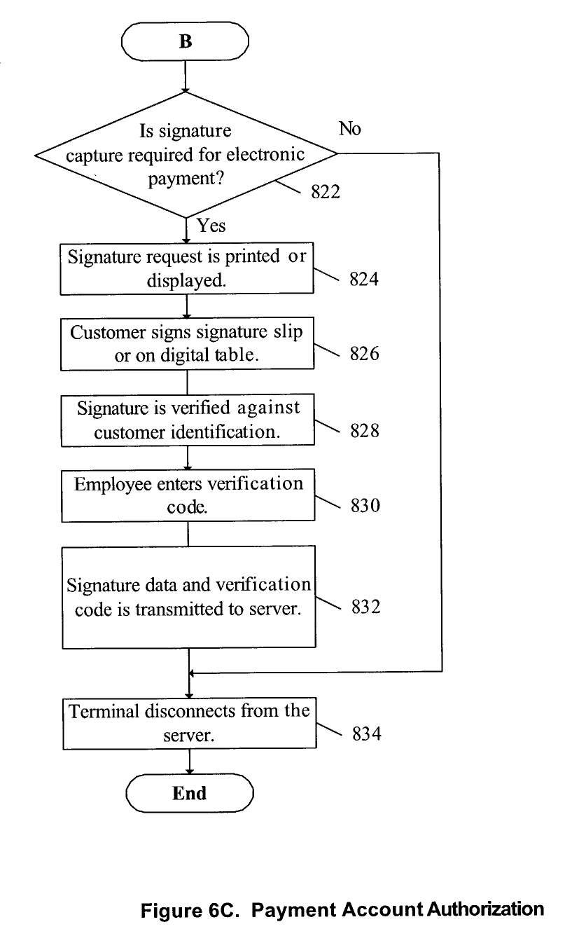

If the authorization is not received (696) the terminal informs the customer of the failure (698) through the display (126). The customer has the option to try another payment credential (700). If the customer chooses not to proceed the process is terminated. If the customer chooses they can present a new payment credential (702) and the payment account information is captured (704). The payment account is authorized using the process shown in FIG. 6 (706).

If data synchronization is required (708) the contents of the terminal cache or nonvolatile memory (110) is synchronized with the host. Finally, the transaction data is stored (712) in the transaction data (110) in the nonvolatile memory or cache for latter synchronization and settlement.

In an alternative embodiment, a signature is captured as part of the electronic payment process. The signature can be captured on a paper slip or in digital form. The need to capture a signature is determined by the payment processor or payment association rules and the merchants risk management polices.

Refunds and Reversals

The preferred embodiment of the invention enables merchants to issue refunds to customers using the merchant payment terminal of POS systems (50).

A unique transaction number printed on the customer's receipt is used to retrieve specific transaction information or the customer's identifier is used to retrieve the transaction record for that customer from which the correct transaction is selected. If the transaction is still in the nonvolatile memory (110) it is recalled from the transaction data (114) and displayed on the terminal display (126). The merchant employee can then issue a full or partial refund. A manager authorization code may need to be entered depending on the merchant's business rules. The refund information is logged in the transaction data record at the conclusion of the transaction. A printed receipt is generated on the printer (102) and presented to the customer. This process allows refunds to be processed offline without the need to connect to the server.

If the transaction data (114) of interest is no longer in the nonvolatile memory (110) the terminal connects to the server through the terminal communications system (44). A unique transaction number printed on the customer's receipt is used to retrieve specific transaction information from the server or the customer's identifier is used to retrieve the transaction record from the server for that customer from which the correct transaction is selected. The merchant employee can then issue a full or partial refund. A manager authorization code may need to be entered depending on the merchant's business rules. A printed receipt is generated on the printer (102) and presented to the customer. The refund information is logged in the transaction data record at the conclusion of the transaction.

Customer Account Creation

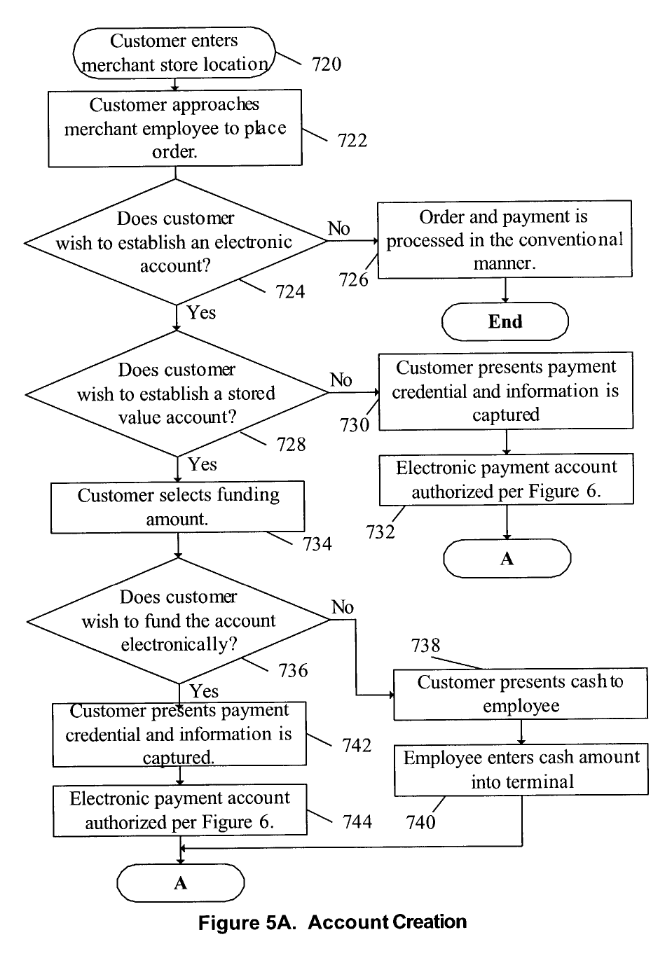

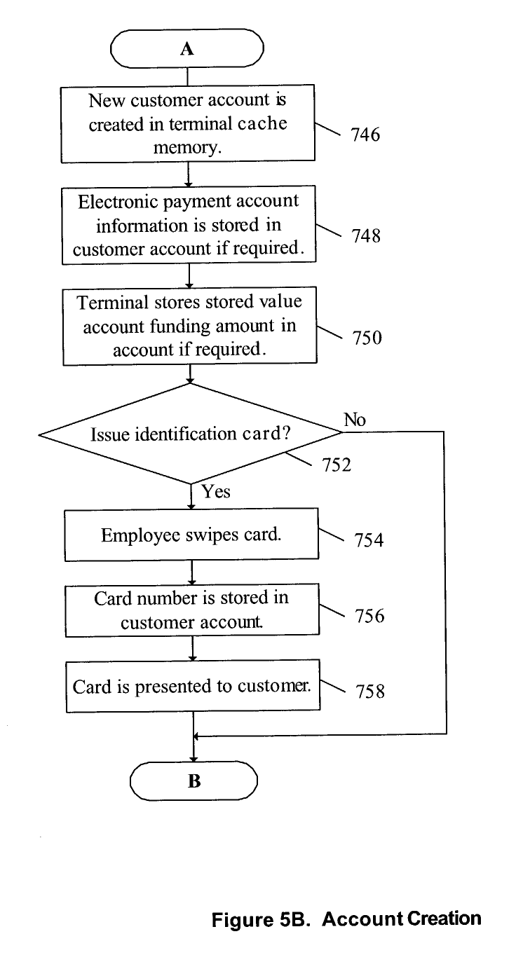

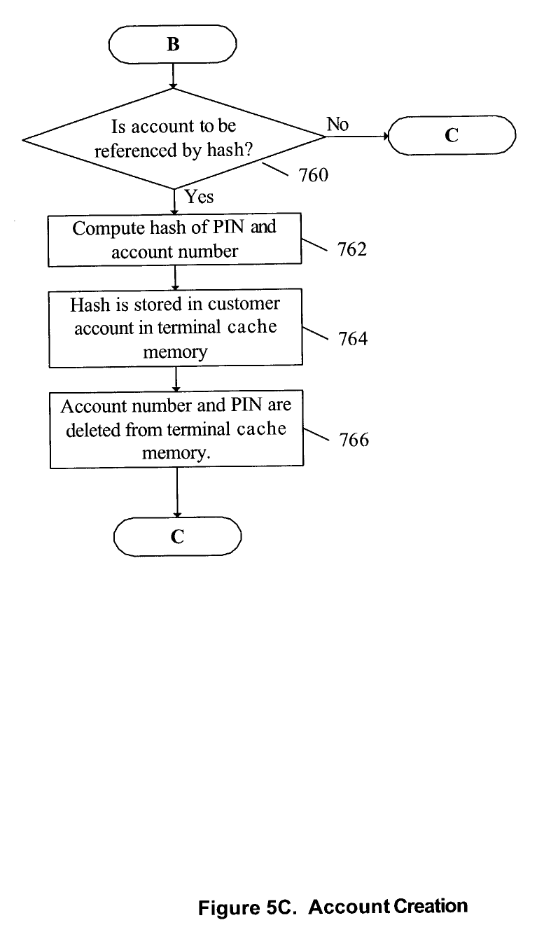

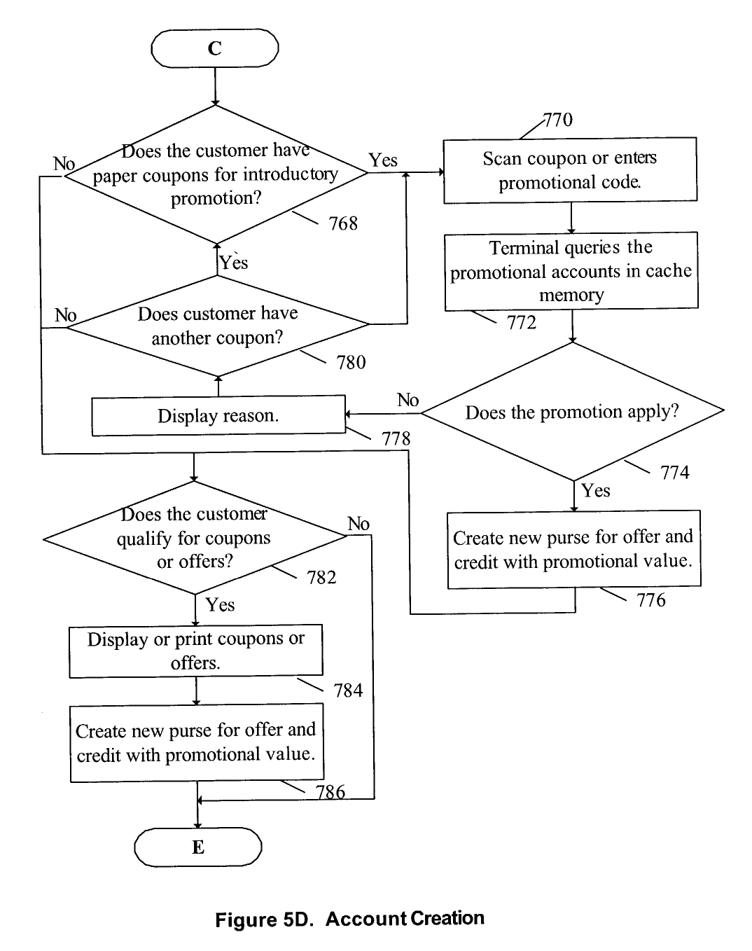

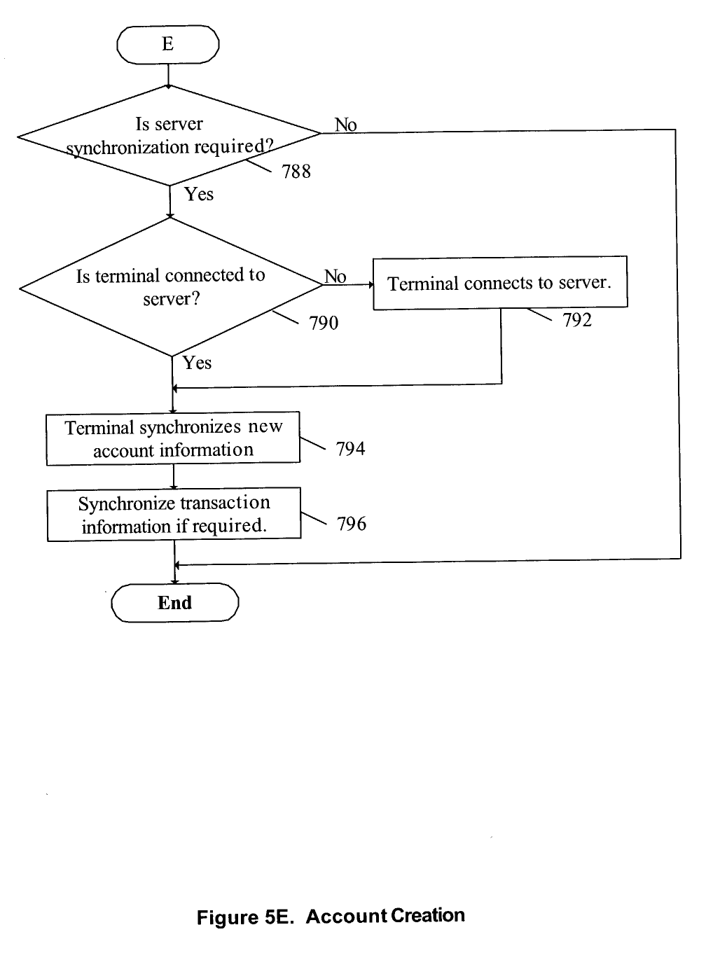

New customers will typically create new accounts for the payment system of the invention at a merchant's point of sale. The process flow for creation of a new customer account is shown in FIGS. 5A, 5B, 5C, 5D, and 5E. At the same time, an electronic payment account is typically authorized following the process shown in FIGS. 6A, 6B, 6C. It will be understood that the customers can establish accounts remotely using a customer access device (52) connected through the customer access gateway (42) to the payment server of the invention. This remote process follows essentially the same flow discussed in this section. Verification of identity and signature capture will be delayed until the customer is physically present at the merchant's location (typically performing the first transaction with the new account).

When a customer enters a merchant's business location (720) and approaches a merchant employee (722), typically to place an order for goods or service, the customer is asked if they wish to establish an account (724) for the electronic payment system of the invention. If not, the customers order and payment is processed in a conventional manner (726).

Payment Account Creation

The customer is asked if they wish to establish a stored value account (728). If not, the customer presents a payment credential (730, the information is captured from the credential, and the electronic payment account is authorized following the process shown in FIG. 6 (732).

If the customer does want a stored value account they select the funding method (734). If the customer wishes to fund the stored value account electronically (736) they present the electronic payment credential (742) and the information is captured. The payment account is then authorized following the process shown in FIG. 6 (744).

The customer presents cash to the merchant employee if the customer wishes to fund the stored value account with cash (738) (or check). Alternatively, the customer can feed cash into the bill acceptor (120). The merchant employee enters (740) the cash amount using the keyboard (124). Alternatively, the bill acceptor captures the cash amount.

Account Established

Once payment choices have been activated a customer account is established. The central processor (100) creates a new customer account (746) in the customer account information (112) in the nonvolatile (110) or cache memory. The electronic payment account information (748) and stored value account payment funding information (750) is stored in the customer account information (112).

If an identification card or other credential is to be issued (752), the employee swipes the card (754) with the card swipe (122) and the card number is captured (756) and stored in the customer account information (112). The card is then presented to the customer (758).

If the account is to be indexed by a stored by a hash rather than an account number (760) the central processor (100) computes the hash of the PIN or other shared secret information and the account number (762) and optional security code information. The hash is stored (764) in the customer's account information (112) and the actual values of the PIN and account number are deleted from nonvolatile (766) and volatile memory.

Creation of Promotional Accounts

Promotional accounts are created at the same time the customer's account is established. New purses are created based on paper coupons or promotions as well as electronic promotions.

If the customer has paper coupons or other introductory promotional offers (768) the information, including promotion codes, from these coupons is scanned (770) with the optical scanner (128) or manually entered using the keyboard (124). The central processor (100) queries the business rules (116) to determine if the promotion applies (774). If the promotion does not apply the terminal informs the customer using the display (126). If the customer has another coupon (780) the process is repeated.

If the coupon does apply, the central processor creates a new promotional purse in the customer account information (112) and stores the value of the promotion (776).

The central processor (100) determines if the new customer qualifies for other introductory coupons or promotions (782) using information in the business rules (116). If the customer is qualified the prints using the printer (102) or shows on the display (126) the coupons and offers the customer qualifies for (784). If the coupon or promotion does apply, the central processor creates a new promotional purse in the customer account information (112) and stores the value of the promotion (786).

Synchronization

If the terminal (50) is required to synchronize upon completion of the customer account creation process (788) the central processor (100) determines if a connection to the server exists through the communications interfaces (106). If not, a connection is established (792). The terminal and server then synchronize (794) the new customer account information (112) and other data in the nonvolatile memory if required (796).

Payment Account Authorization

Whenever a new electronic payment account is to be used by the customer the account must be authorized for use by the payment processor. This process is shown in FIGS. 6A, 6B, and 6C. Once authorized the customer can use the payment account under the terms and conditions stated in the service agreement on a repetitive basis, generally without the need for additional authorization procedures by presenting a payment credential and providing shared secret information. Suitable payment types include credit and online debit accounts as well as offline debit methods such as checks and Automatic Clearing House (ACH) payments. The process described here is intended to be real-time and uses an online authorization for the payment processor as a significant step in the process. However with offline payment methods, a delay may be required to ensure the verification of the payment account information before the account can be used for transactions. Limitations on new accounts are discussed latter in this document.

When a new electronic payment account needs to be authorized the terminal determines the connection path to the processor (799) and connects (800) through the communications interfaces (106) to the server of the payment system of the invention through the terminal communications system (44), which connects to the payment processor (56) through the payment switch (14). Alternatively, the terminal (50) can connect directly to the external payment processor's server (56) through the communications interfaces (106).

Connection to the server is used to invoke globally controlled fraud management processes. The transaction manager (10) evaluates the fraud score of the account using the fraud profile database (58) and determines if this score is acceptable (802). Alternatively, the external payment processor (56) computes the fraud profile score. If the score for the customer is not acceptable the authorization process is terminated. Fraud management is discussed latter in this document.

The terminal requests an authorization and if this authorization is not received (804) the customer is informed of the failure (806) through the display (126). If the customer wishes to try another electronic payment account (808) and if there have not been too many attempts (810) the process is repeated. If the customer does not wish to try another electronic payment account the process terminates. The fraud management processes managed by the server or the invention, and discussed latter in this document, determine the number of tries allowed.

Once an authorization has been received from the payment processor (56), shared secret information is collected from the customer if this is required (812). Alternatively, shared secret information previously collected for the account can be used. The terminal asks the customer to enter shared secret information (814) through the display (126) and in response the customer enters the shared secret information (816) using the keyboard (124). The terminal asks the customer to reenter shared secret information (818) through the display (126) and in response the customer reenters the shared secret information (819) using the keyboard (124). If the two entries do not agree (820) the process is repeated.

Suitable shared secret information includes Personal Identification Numbers (PIN) or password. In an alternative embodiment, biometric identifiers are used instead of shared secret information, and can include, fingerprints, handprints, voiceprints, and retinal scans. In another alternative embodiment cryptographic security information contained in the customers wireless access device (52) is used, and can include, PKI certificates, symmetric secret key cryptographic methods or asymmetric secret key cryptographic methods. These alternatives in no way change the nature or function of the invention.

If signature capture and customer identification is required to authorize the payment account (822), the terminal requests the customer's signature (824) through the display (126) or producing a signature slip with the printer (102). The customer signs the signature slip or on a digital tablet attached as a peripheral to the terminal (826). The merchant employee verifies (828) the customer's signature and identity, ideally using a photo identification credential. The employee then enters a verification code into the terminal (830) using the keyboard (234). The verification code and digital signature information (if any) is transmitted to the server (832) for storage. At the end of the authorization process the terminal disconnects from the server (834).

The digital signature or paper signature slip is archived for latter retrieval in the event of a dispute between the customer and the merchant. The printed slip contains either a full or summary of the contract showing the terms and conditions for use of the payment system of the invention by the customer. Full versions of the contract can be provided in printed form at the merchant's location or sent through the mail. Alternatively, electronic versions of the full contract can be supplied by email or through an Internet web site.

Terminal Nonvolatile Memory Structure

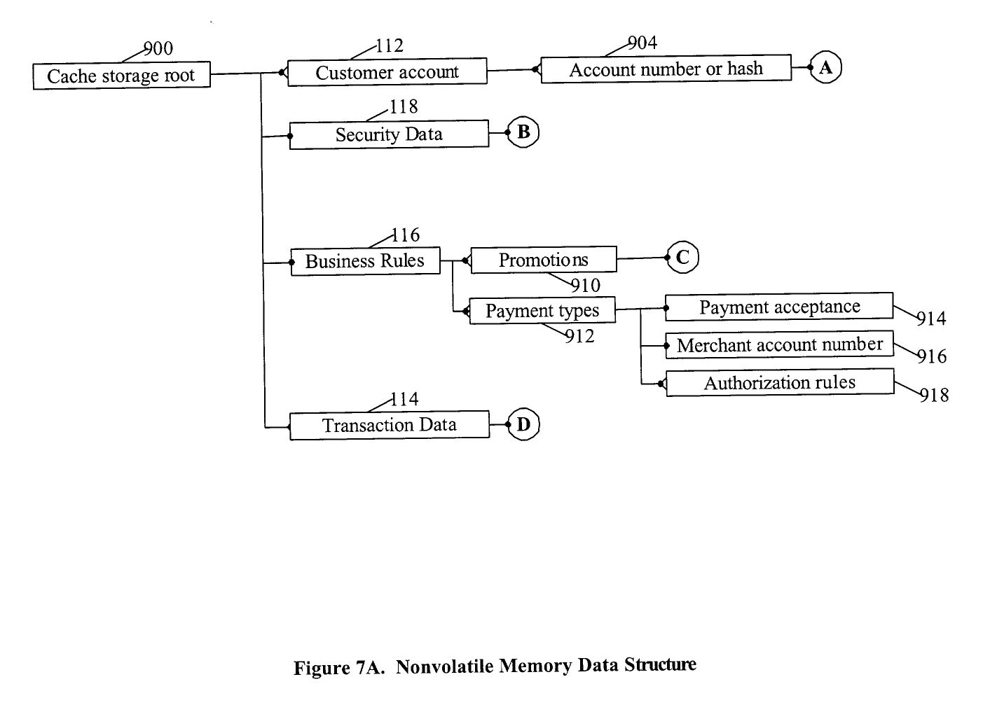

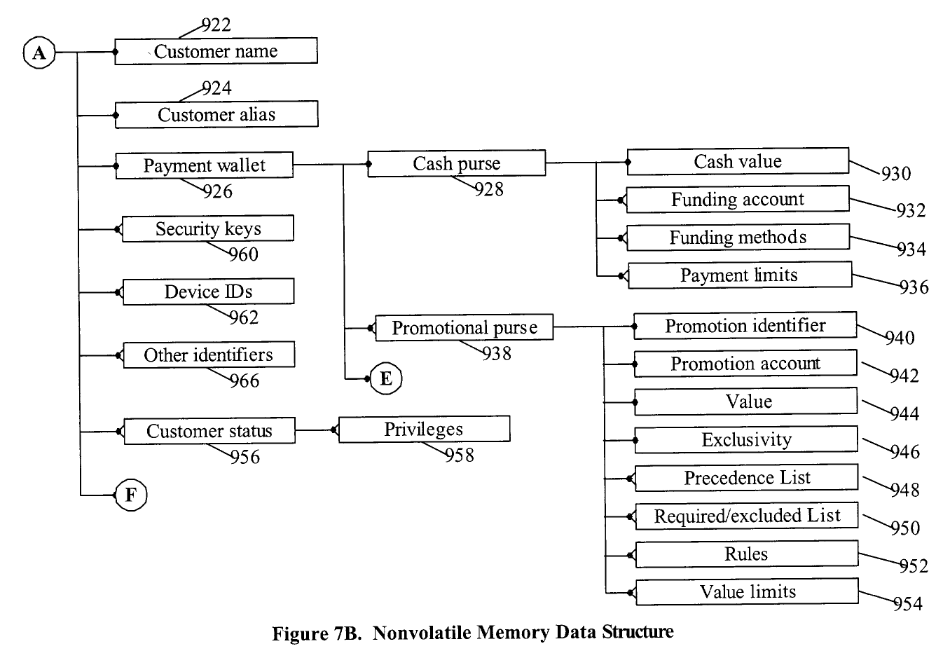

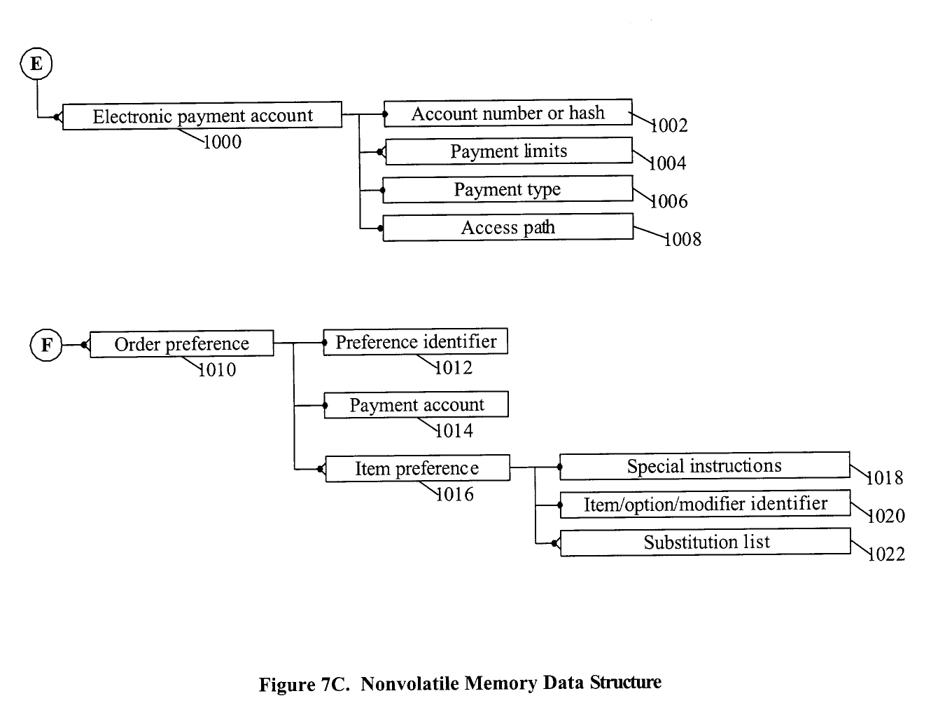

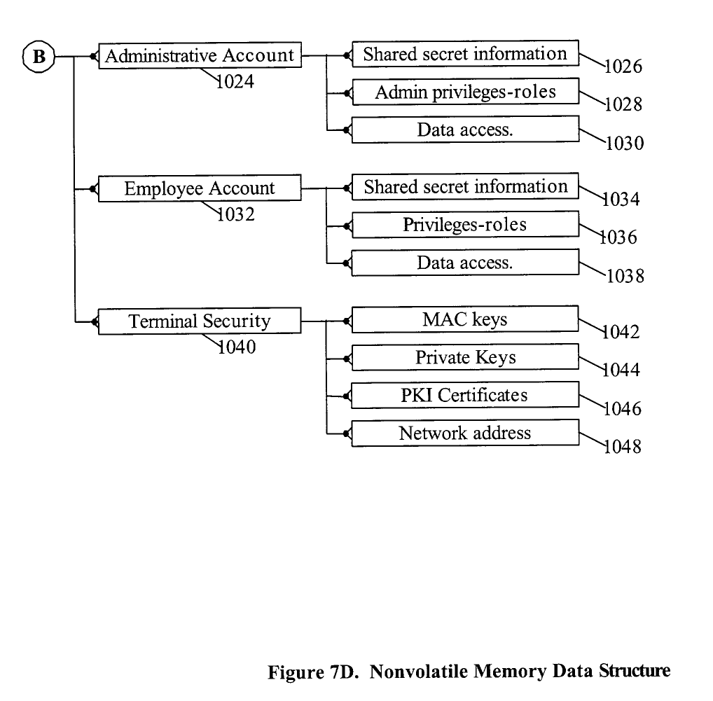

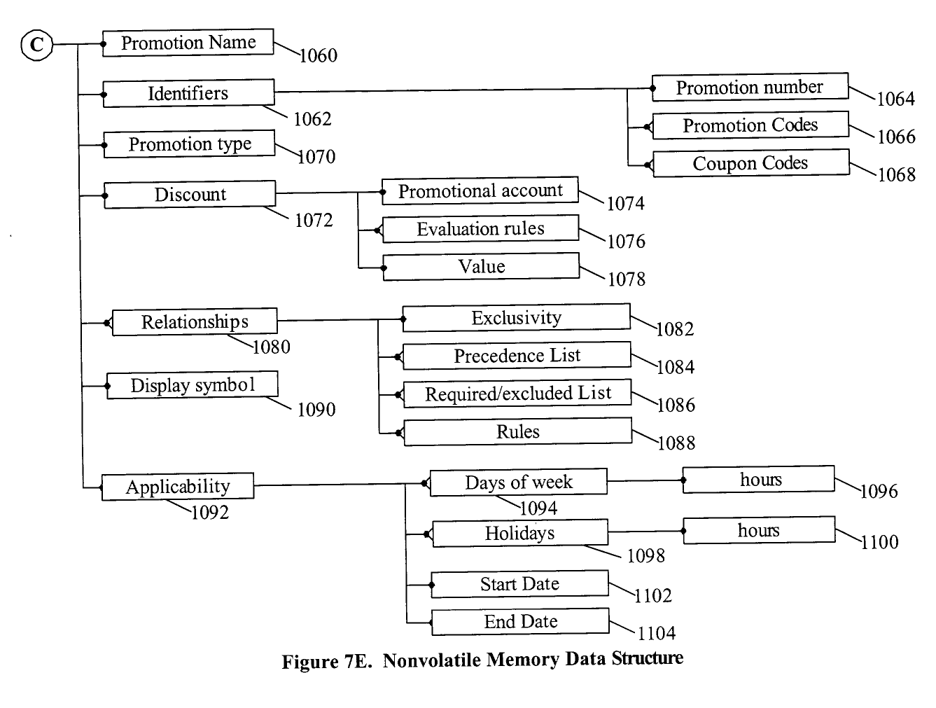

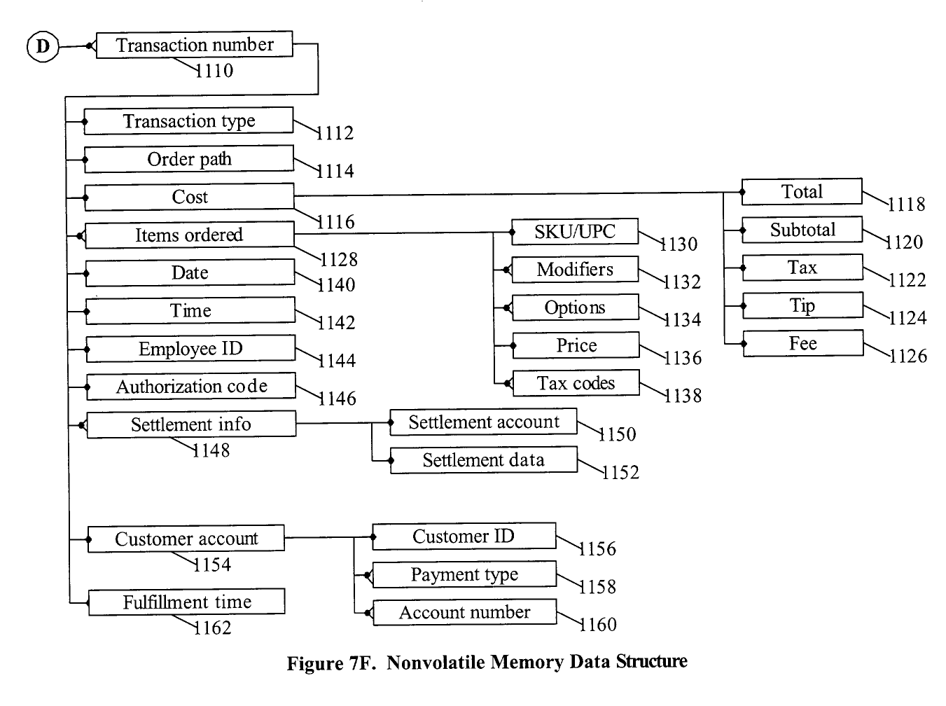

All information required for the terminal to independently process payment transactions is held in the merchant terminal's (50) nonvolatile memory (110). This memory contains customer account information (112), transaction data (114), business rules (116) and security data (118). The structure of the information in the nonvolatile memory is shown schematically in FIGS. 7A, 7B, 7C, 7D, 7E and 7F. This information is accessed and used by the central processor (100) during payment and loyalty transactions. The information in the nonvolatile memory is synchronized over a data network with the information held in the server at times determined by either the transaction flow and volume at the terminal or global merchant fraud management processes run on the server.

In the preferred embodiment of the invention, the nonvolatile storage is organized as a tree or hieratical schema with a root (900). The nonvolatile memory (110) can be stored in a number of ways, depending on the exact configuration of the merchant terminal equipment (50). For example, if a standalone payment terminal is used the required information can be stored in flash memory on the terminal. In another example, with a multi-point or multi-lane POS system, the required information can be stored on a hard disk in the POS system server.

Customer Account

The customer account information (112) contains information required for customer payment and loyalty transactions. The customer account information stored in the terminal (50) nonvolatile memory (110) would only include the information required to perform payment and loyalty transactions at that specific store location. Customer account information pertaining to other merchants or locations would not be loaded into the nonvolatile memory at a particular merchant location at any time.

The data in the customer account (112) preferably contains:

1) A unique account number (904) which may be stored as a hash of other information (i.e. account number and PIN) for security purposes,

2) Customer name (922),

3) User name or customer alias (924) used for account access,

4) Security keys (960) or other security information required to interact with customer wireless access devices (52),

5) Telephone number or other device identifiers (966), along with device type or capability information including device ID, such as, IP address, device capabilities for display, device capabilities for security, etc,

6) Customer status (956) information including information on privileges (958) the customer may have as a result of their status, and

7) Customer order prefaces (1010), preferably including,

a) A unique preference identifier (1012),

b) The payment account (1014) used to pay for the preference,

c) Item preferences (1016) comprising the order and composed of special instructions (1018) for the item, option or modifier identifier choices (1020) for the item, and a substitution list (1022) if the item is not available.

The customer account information (112) includes a payment wallet (926) containing all payment information and loyalty account information in one or more purses. The payment wallet preferably contains,

1. One or more cash purses (928) with stored value account information (i.e. a prepaid account) and including the cash value of the account (930), the electronic funding account (932) for the stored value account, the funding method (cash, electronic, etc.) (934) for the stored value account, and payment limits (936) used for fraud management with the stored value account,

2. Promotional value purses (938) preferably containing:

a. Information identifying the promotion (940),

b. The merchant promotional account (942) against which the value of the promotion is debited,

c. The value of the promotion (944) to the customer,

d. The exclusivity (946) of the promotion with respect to other promotions,

e. The precedence (948) rules and parameters for the promotion with respect to other promotions,

f. Lists of required or excluded items (950) for the promotion to apply,

g. Rules for the application of the promotion (952) to the order, and

h. Value limits (954) on the promotion used to prevent fraud,

3. Electronic payment account (1000) information including,

a. The account number (1002), account reference used by the server to determine account number, or hash of the account number if the account number is not stored directly for security reasons,

b. Payment limits (1004) for use of the account without additional (typically online) authorization,

c. The payment type (1006), such as credit, debit, etc., and

d. The access path (1008) or processor information for that account.

Business Rules

The nonvolatile memory (110) contains information on business rules (116) that are applied to payment and loyalty transactions. Preferably, the business rules contain the following information:

1. Payment types accepted at that merchant location and including the acceptance information (914) for that payment type, the merchant account number (916) used for settlement and the authorization rules (918) and limits for that payment type, and

2. The promotions (910) accepted at that merchant location and preferable including the following information,

a. A name (1060) which the customers and merchant employees use to identify the promotion,

b. Internal identifiers (1062) for the promotion, which may include a promotion number (1064), promotion codes (1066) for tracking the promotion usage, and coupon codes (1068) used to tie electronic promotions to paper coupons and advertisements,

c. An indicator of the promotion type (1070),

d. The discount (1072) applied for the promotion, which may include, the merchant's promotional account (11074) to which the value of the promotion is debited, evaluation rules (1076) used to determine the value and applicability of the promotion, and the value (1078) parameters of the promotion,

e. Display symbols (1090) used to communicate to merchant employees that the promotion is applicable to the order and what the promotion is,

f. Relationships (1080) for application of the promotion, which may include; the exclusivity (1082) parameters of the application of the promotion to the order verses other promotions, the precedence (1084) for this promotion with respect to the applicability of other promotions, a list of items in the order that must be included or excluded (1086) for the promotion to be valid, and rules (1088) for the application of the relationship parameters, and

3. The applicability (1092) parameters and rules of the promotion, which may include;

a. Applicable hours (1096, 1100) for the promotion by days of the week (1094) and holidays (1098)

b. The start date (1102) of the promotion, and

c. The end data (1104) of the promotion.

Transaction Data

The transaction data (114) for the merchant location is stored in the nonvolatile memory (110). The transaction data contains the transaction history record and is synchronized as required with the data stored on the payment system servers. This transaction information is used for reporting on merchant account (30) activity performed by the report generator (22), customer account (28) activity, settlement for electronic payment accounts as performed by the settlement manager (20), and logging transaction information for auditing and archival purposes in the ledgers (32) and data warehouse (38). The transaction data stored on the terminal preferably includes,

1) The transaction number (1110) for each transaction,

2) The transaction type (1112) (refund, sale, etc.),

3) The order path (1114) (in person, drive through, Internet, telephone, etc.),

4) The cost of the transaction (1116), including, as appropriate, parameters for the total cost (1118), a subtotal (1120) of the goods and services ordered, the applicable taxes (1122), tip (1124), which may include a shift identifier or identifier for individual employees, and remote order or service fee (1126),

5) A list of the items ordered (1128), including, as appropriate, parameters for the SKU, UPC or other product identifier (1130), modifiers for the item (1132), options for the item (1134), the unit price (1136) of the item, and the applicable tax codes (1138) for the item,

6) The date (1140) of the transaction,

7) The time (1142) of the transaction,

8) The ID (1144) of the employee or manager handling the transaction,

9) An employee or manager authorization code (1146) if required for the transaction,

10) Information on the applicable settlement accounts (1148) for payment and promotions including, the settlement account or DDA number (1150), and settlement date (1152),

11) The customer account (1154) used for the transaction including, the customer ID (1156), the payment types (1158) used, and the account numbers (1160) used for payment and loyalty, and

12) Information on the customer order fulfillment time (1162).

Security Data

Security data (118) required for applying security policies for transactions, administration and reporting at each individual store location is stored in the nonvolatile memory (110). The security information preferably contains the following;

1) Information for the store level payment system administrative account (1024) and including, shared secret information (1026) for access to the administrative account, rules and data for the administrative roles and privileges (1028) for the administrative account, and data access rules and information (1030) for the administrative account,

2) Employee account (1032) information and including, shared secret information (1034) for access to the employee account, privileges and roles (1036) for the employee account, and data access (1038) privileges for the employee account, and

3) Terminal security information (1040) for system or network access to the merchant terminal equipment (50) or POS system and including, Massage Authentication Code (MAC) keys (1042), secret key cryptographic (1044) information, Public Key Cryptography (PKI) certificates (1046) and other public key cryptographic information, and network addresses (1048) or other network or equipment identifiers.

Terminal Data Synchronization

Data stored in nonvolatile memory (110) on the merchant terminal equipment (50) must be synchronized with the customer account (28) information, merchant account (30) information, ledgers (32), security information store (34) and data warehouse (38) records in the server database (24). Synchronization ensures that the information in the merchant terminal equipment, at possibly many store locations, and the server database is in agreement and that the state of account and transaction information is up to date enough for transaction processing, reporting and settlement.

During data synchronization the merchant terminal equipment (50) connects to the payment system server through the terminal communications system (44). Data synchronization occurs under the control of the transaction manager (10) and the security manager (18) on the payment system server. Frequency and timing of synchronization events is determined by a combination of multiple factors including the following:

1) Frequency of transactions at a location,

2) Value of transactions at a location,

3) Time of day and day of week and timing of employee shifts,

4) Number and frequency of transactions where the customer account information is not in the terminal cache memory,

5) Number and frequency of new account creation and authorization events, and

6) Fraud management strategies for a location. Fraud management is discussed below.

Capacity Management

The peak transaction processing capability of the preferred embodiment of the payment system of the invention is extended through network and server capacity management. With dial-based data network connections the number of ports available in the terminal communications system (44) often limits the system capacity. In other cases, network bandwidth limitations or server and storage read/write speed limitations determine the maximum online transaction rate for the payment system. In all cases, the economics of operating the payment system are improved if a greater peak transaction rates are achieved without requiring additional capital equipment or telecommunications capacity.

The terminal communications system (44) under the control of the transaction manager (10) regulates synchronization processes to optimize transaction capacity of the system. Primary capacity regulation in the payment system of the invention is achieved by caching customer account information (112) and transaction data (114) in the nonvolatile memory (110) in the merchant terminal equipment (50). Those transactions that can be completed using this cached information require no server or telecommunications resources. Examples of capacity management strategies that can be employed with the preferred embodiment of the invention include:

1. Delay synchronization for reporting and settlement purposes during peak transaction periods,

2. Synchronization of data when an online payment authorization is required, and

3. Synchronization of data when a new account is activated or an account is deactivated.

Account Number Hashing and Referencing

For security of account number information and to comply with some payment association and payment network rules account number information and PIN codes (or other shared secret information) are not stored directly in the nonvolatile memory (110) on the merchant terminal equipment (50). In the preferred embodiment of the invention, a non-reversible cryptographic hash of the customer payment account number and the PIN (sometimes referred to as a PIN offset) is stored. Thus, there is no permanent record of payment account numbers or shared secret information on the terminal. Account number information need only be stored in the secure payment system server. When the payment system server receives transaction data with hashed account numbers the transaction manager (10) performs a lookup in the customer account (28) to retrieve the unencrypted payment account number (possibly using a reference indicator 1002 if more than one payment account is active). The actual payment account number is then used for processes such as transaction logging in the ledgers (32) and data warehouse (38) and settlement processes executed by the settlement manager (20).

Network Cost and Capacity Management

In the preferred embodiment of the invention multiple data network paths or connections are used between the terminal communications system (44) and the merchant terminal (50). The connection or network path used depends on the costs or rate structure of the connection options and the transaction rates or bandwidth requirements. For example, a demand dial connection is typically billed based on a rate structure involving a connection or setup charge along with a per-minute charge. A continuous network connection is often billed on a variable basis depending on the time of the day (bulk rates from ISPs are billed in hourly increments and can depend on the time of the day). Yet other data connections (such as wireless data networks) are billed on the basis of the number of data packets (typically of a fixed size) sent and the time of day or day of the week. The terminal communications system can compute the most economical connection option based on the rate table for each option at each time of day and day of the week, the predicted number of transactions, and the predicted volume of data requiring transfer for synchronization in a give period of time. As history on transaction volume and volume of synchronization data is developed, the terminal communications system can improve these predications. The terminal communications system then uses the lowest cost option and instructs the terminal which connections to use at different times during the day and day of the week. When a transaction requires a connection from the terminal to the server, the central processor (100) picks the lowest cost communications interface (106) based on these instruction.

Network and Server Failure

In the event of network or server failure, the preferred embodiment of the invention supports offline loyalty and payment transactions using the customer account information cached in the nonvolatile memory of the payment terminal. Alternative payment methods are used for transactions where the customer account information is not in the terminal memory. These alternatives include payment in cash or electronic payment where the terminal receives an authorization by directly connecting to the external payment processor (56), possibly at a higher transaction and network cost. Loyalty points and other records can be collected in the terminal's nonvolatile memory for any customer account and are transferred to the server during synchronization once service is restored. Redemption of coupons, promotions and loyalty points can only occur for customers whose account information has been cached on the terminal.

Customer Account Fraud Management

The preferred embodiment of the distributed payment and loyalty system includes fraud prevention capabilities. The security manager (18) controls the fraud prevention processes using information in the data warehouse (38), the customer account (28), ledgers (32) and external fraud profile databases (58). The security manager also applies information received from the external payment processors (56), which can be in the form of authorizations, fraud profile information or fraud scores. Using this information the security manager applies policies to minimize the merchant's fraud risk while balancing the costs of performing transactions online verses offline and potential lost business from not being able to complete transactions that have too high of a fraud potential score. To enforce limits on accounts the security manager sets and dynamically updates security rules used by the transaction manager (10), the customer access gateway (42), the terminal communications system (44) and the merchant terminal equipment (50).

1. Randomly samples for synchronization data.

2. Sets “floor limits” on value and frequency for terminals for both new and established accounts based on fraud scoring.

3. Can limit number of terminals with SVA balances to prevent “multi-point” attacks.

4. During synchronization information on deactivated accounts is removed from the terminal's catch.

5. Profiles accounts and deactivates or “puts on watch” bad or questionable accounts. On watch accounts are not cached to terminal and removed from terminal cache and may only be processed on line.

Fraud Profiling and Scoring

The security manager (18) scores customer accounts for fraud potential at payment account activation time and continues to profile ongoing account activity to detect fraud. The security manager supplements ongoing profiling with fraud scoring (particularly from external scoring services). Through the profiling and scoring process, the security manager determines parameters for rules used to limit merchant payment or fraud risk within constraints of limiting costs and lost business. These rule parameters are changed dynamically based on updated profiling and scoring information. Scoring a profiling techniques applied by the security manager include for both new and ongoing accounts,

1. Checking “stop files” for known bad account numbers,

2. Digit checks to confirm the validity of the account number or financial institution outing number,

3. Checks for non-issued account numbers (not yet issued) or inactive account numbers,

4. Account PIN verification,

5. Account holder address and telephone number verification,

6. Account expiration date,

7. Frequency of purchases and sudden changes in frequency of purchases,

8. Individual and total value of purchases per time period and sudden changes in these parameters,

9. Limits on velocity between purchase location,

10. Sequence numbers for checks,

11. Reports of stolen account information or credentials,

12. Customer history of valid use (time, total value of purchases, etc.),

13. Sudden changes in purchasing behavior (frequency, value, location, etc.), and

14. Declined authorization requests and reasons for decline.

Fraud Management Through Synchronization of Account Information

The security manager (18) and the transaction manager (18) control the synchronization of information in the nonvolatile memory (110) of the merchant terminal equipment (50). The timing or frequency of synchronization is determined by capacity demand on the servers and network facilities, frequency of online payment transactions and security requirements. The security manager (18) computes the timing and frequency of synchronization for each individual merchant location. This timing and frequency is based on a prediction of aggregate or weighted risk score for each merchant location and with the prediction based on a number of factors including:

1. Risk scores of the individual transactions at the location,

2. Frequency or volume of transactions at the location,

3. History or detected fraud incidents at the location or other locations, and

4. Dollar value of the transitions at the location.

Limits on Accounts

Depending on merchant, payment processor and RO system operator business rules and the type of payment account being used by the customer, limits are placed on a newly activated accounts and established accounts. Customer account limits (936) are updated, by the transaction manager (10) through the terminal communications system (44), in the customer account information (112) in the nonvolatile memory (110) of the merchant terminal (50) during the synchronization process. Limits on accounts include:

1. Limits on each type of payment account (e.g. stored value, promotional, credit, debit),

2. Limits on the value of a specific transaction,

3. Limits on the total value of transactions per period of time (e.g. per day),

4. Limits on the number of transactions per period of time (e.g. per day),

5. Limits on transaction location (e.g. locations where the customer account information is cached in the terminal 50),

6. Manager approval required for transaction,

7. Waiting period to establish offline account (e.g. ACH, check guarantee),

8. Limits on items that can be purchased with the payment account, and

9. Cash only customer.

In the preferred embodiment of the invention account limits are set based on fraud scores produced by one or more predictive algorithms run by the Security manager (18) using information gathered from the customer account (28), merchant account (30), ledgers (32), data warehouse (38), fraud profile database (58) and external payment processors (56). Data used in the predication of fraud scores include:

1. Risk score for the customer payment account (see section above),

2. Number of successful or failed transactions for the customer,

3. Time the account has been active,

4. Level of account activity,

5. Merchant locations at which the account is used,

6. Sudden changes in account activity,

7. Method of payment (e.g. cash, stored value, credit, debit) and risk level for each method of payment,

8. Availability of online payment authorizations,

9. History of settlement failures, charge-backs, NSF conditions, stop payment, etc., and

10. Changes in payment account being used.

Payment Account Expiration

Certain electronic payment account types (e.g. credit accounts) have expiration dates. These dates are either verified by the transaction manager or will be sent as a reason for a declined authorization request from the external payment processor (56) through the payment switch (14). In other cases, the customer may close a payment account and forget to update their payment account information in the customer account (28). In this case, the transaction manager (10) will typically be informed of the closed account situation by the external payment processor (56) when a settlement fails.

Once a payment account has expired, the customer account information (112) in the nonvolatile memory (110) is updated during synchronization with the server. Following synchronization the customer account information cached on the terminal (50) indicates that the customer's electronic payment account has expired.

When the customer attempts to use an expired payment account or a closed payment account they are notified by the transaction manager (10) of the problems on their customer access device (52) through the customer access gateway (42) or on the merchant terminal (50) through the terminal communications system (44). The notification can be in electronic display or printed form. The customer then has the options to either update the electronic payment account being used following the processes shown in FIGS. 5A, 5B, 5C, 5D and 5E and FIGS. 6A, 6B and 6C or to pay or fund a stored value account with cash. Once a new electronic payment account has been authorized the customer account information is updated to indicate this fact.

Customer Account Interface

In the preferred embodiment of the invention, customers can interact with the payment system of the invention using their wired or wireless customer access device (52) through the customer access gateway (42). Through this interface a customer can manage their account, receive account reports and fund accounts.

Account Management

The customer interface through the customer access gateway (42) using a customer access device (52) affords the same features for account creation and management (i.e. update payment account) available through the merchant terminal (50) through the terminal communications system (44).

Account Reporting

Customers can receive account reports on their customer access device (52) through the customer access gateway (42). These reports include information such as the balance of stored value and promotional accounts, transaction history and transaction details.

Account Funding

Customers can electronically add funds to a stored value account using their customer access device (52) through the customer access gateway (42). This process follows essentially the same process as would be performed at the merchant terminal (50).

We claim:

1. A method for providing offline payment and loyalty capability in which the customer account information is stored in a nonvolatile memory on a terminal at one or more merchant locations and comprising:
one or more secure servers or host systems,
a data network connecting the one or more servers to the one or more terminals,
a customer account identifier,
shared secret information used of customer account security, and
customer account information is referenced in the nonvolatile memory by a cryptographic hash of a customer account identifier, optional other security codes, and some shared secret information.

2. The method of claim 1 wherein the shared secret information is an alphanumeric code.

3. The method of claim 1 wherein the customer identifier is a magnetic card.

4. The method of claim 1 wherein the customer identifier is a smart card.

5. The method of claim 1 wherein the customer identifier is a wireless device.

6. The method of claim 1 wherein the customer identifier is a telephone number.

7. The method of claim 1 wherein the customer identifier is a optically (bar) coded card or other medium.

8. The method of claim 1 wherein transactions can be executed using the customer account information stored on the one or more merchant terminals in the event of a failure of the network or the one or more servers.

9. The method of claim 1 wherein the customer account information on each of the one or more merchant payment terminals is synchronized with the customer account records on one or more servers over the data network.

10. The method of claim 9 wherein the identification of specific customer accounts to be synchronized between the one or more servers and the one or more merchant payment terminals, where a predictive algorithm, using past customer behavior, determines which merchant locations at which the account information is stored in the nonvolatile memory.

11. The method of claim 9 wherein customer accounts with high risk-scores are not stored in the nonvolatile memory of the one or more payment terminals during the synchronization process.

12. The method of claim 9 wherein the volume of information exchanged and timing of the exchange between the one or more servers and one or more merchant location payment terminals is determined by the volume of transactions being processed on the payment terminals and the capacity of the servers and the network connecting the servers to the terminals.

13. The method of claim 1 wherein the merchant location is an unattended sale or vending location.

14. The method of claim 1 wherein the customer payment account information references a debit account on a demand deposit account.

15. The method of claim 1 wherein customer payment account information references a credit account.

16. The method of claim 1 wherein the customer payment account information references a stored value or prepaid account.

17. The method of claim 16 wherein the customer can fund the stored value or prepaid account through the one or more payment terminals without the need for a network connection to the one or more servers.

18. The method of claim 16 wherein the customer can fund the stored value account using an electronic payment account.

19. The method of claim 16 wherein the customer can fund the stored value account using cash.

20. The method of claim 1 wherein the customer can select one or more payment accounts to use for a given transaction.

21. The method of claim 1 wherein the translation between the cryptographic hash, a possible other account selection code, and the actual customer electronic payment account numbers or customer account numbers is performed on the secure server.

22. The method of claim 1 wherein loyalty value is accumulated in the customer account in the nonvolatile memory of the merchant terminal without the need to connect to the one or more servers over the data network.

23. The method of claim 1 wherein loyalty value is automatically applied to the customer purchase by the merchant terminal without the need to connect to the server.

24. A method for providing offline payment and loyalty capability in which the customer account information is stored in a nonvolatile memory on a terminal at one or more merchant locations and where the customer can use and fund a stored value or prepaid account and comprising:
one or more servers or host systems
one or more payment terminals at merchant retail locations
a data network connecting the one or more servers to the one or more terminals, and
a customer account identifier.

25. The method of claim 24 wherein shared secret information is used as a security measure to access the customer account.

26. The method of claim 25 wherein the customer account information is referenced by a cryptographic hash of the customer account identifier and the shared secret information.

27. The method of claim 26 wherein the shared secret information is an alphanumeric code.

28. The method of claim 24 wherein the customer identifier is a magnetic card.

29. The method of claim 24 wherein the customer identifier is a smart card.

30. The method of claim 24 wherein the customer identifier is a wireless device.

31. The method of claim 24 wherein the customer identifier is a telephone number.

32. The method of claim 24 wherein the customer identifier is an optically (bar) coded card or other medium.

33. The method of claim 24 wherein transactions can be executed using the customer payment account information stored on the one or more merchant terminals in the event of a failure of the network or the one or more servers.

34. The method of claim 24 wherein the customer account information on each of the one or more merchant payment terminals is synchronized with the customer account records on one or more servers over the data network.

35. The method of claim 34 wherein the identification of specific customer accounts to be synchronized between the one or more servers and the one or more merchant payment terminals, where a predictive algorithm, using past customer behavior, determines which merchant locations at which the account information is stored in the nonvolatile memory.

36. The method of claim 34 wherein the volume of information exchanged and timing of the exchange between the one or more servers and one or more merchant location payment terminals is determined by the volume of transactions being processed on the payment terminals and the capacity of the servers and the network connecting the servers to the terminals.

37. The method of claim 24 wherein the merchant location is an unattended sale or vending location.

38. The method of claim 24 wherein the customer can fund the stored value account using an electronic payment account.

39. The methods of claim 26 and claim 38 wherein the translation between the cryptographic hash and actual customer electronic funding account numbers is performed on the secure server.

40. The method of claim 38 wherein the electronic funding account is a debit account on a demand deposit account.

41. The method of claim 38 wherein customer electronic funding account is a credit account.

42. The method of claim 24 wherein the customer can fund the stored value account using cash.

43. The method of claim 26 wherein the translation between the cryptographic hash, optional other account identifiers, and the customer payment account number is performed on the secure server.

44. The method of claim 24 wherein loyalty value is accumulated in the customer account in the nonvolatile memory of the merchant terminal without the need to connect to the one or more servers over the data network.

45. The method of claim 24 wherein loyalty value is automatically applied to the customer purchase by the merchant terminal without the need to connect to the server.
